(19) United States
(12) Patent Application Publication
(10) Pub. No.: US 2025/0292802 A1
(43) Pub. Date: Sep. 18, 2025

(54) METHOD AND SYSTEM FOR GENERATING SYNTHETIC VIDEO ADVERTISEMENTS

(71) Applicant: Roku, Inc., San Jose, CA (US)

(72) Inventors: Sunil Ramesh, Saratoga, CA (US); Michael Patrick Cutter, Golden, CO (US); Charles Brian Pinkerton, Boulder, CO (US); Karina Levitian, Austin, TX (US); Greg Humphrey, San Francisco, CA (US); Sergiy Yavorsky, Irvine, CA (US); Jasmine Teer, Los Angeles, CA (US); Juhie Vijayvargiya, Los Angeles, CA (US); Thejaswi Raya, Fremont, CA (US); Damon Van Deusen, Burbank, CA (US); Austin Hepp, Thousand Oaks, CA (US)

(21) Appl. No.: 19/224,575

(22) Filed: May 30, 2025

Related U.S. Application Data
(63) Continuation-in-part of application No. 18/440,353, filed on Feb. 13, 2024, now Pat. No. 12,334,115.
Application No. 18/440,353 is a continuation of application No. 18/319,033, filed on May 17, 2023, now Pat. No. 11,942,116.
Application No. 18/319,033 is a continuation of application No. 18/088,678, filed on Dec. 26, 2022, now Pat. No. 11,741,996.

(51) Int. Cl. G11B 27/031; G06Q 30/0251; G10L 13/02

(52) U.S. Cl. CPC G11B 27/031; G06Q 30/0271; G10L 13/02

(57) ABSTRACT

System, apparatus, article of manufacture, method and/or computer program embodiments are provided for generating synthetic video advertisements. An example method can include obtaining input data that includes one or more business attributes associated with a business; choosing, based on the one or more business attributes, a video advertisement template that includes a plurality of modular elements; producing, based on the one or more business attributes, textual content and image content for promoting the business; generating, based on the textual content, at least one audio track that is associated with one or more of the plurality of modular elements in the video advertisement template; and assembling a synthetic video advertisement by populating the plurality of modular elements in the video advertisement template with the at least one audio track and the image content.

### CROSS-REFERENCE TO RELATED APPLICATIONS

This application is a continuation-in-part of U.S. application Ser. No. 18/440,353, filed on Feb. 13, 2024, which is a continuation of U.S. application Ser. No. 18/319,033, filed on May 17, 2023, now U.S. Pat. No. 11,942,116, which is a continuation of U.S. application Ser. No. 18/088,678, filed on Dec. 26, 2022, now U.S. Pat. No. 11,741,996. Each of the foregoing applications is incorporated by reference herein in its entirety.

### BACKGROUND

### Field

This disclosure is generally directed to processing media content, and more particularly, to systems and methods for generating synthetic video advertisements.

### SUMMARY

Provided herein are system, apparatus, article of manufacture, method and/or computer program product embodiments, and/or combinations and sub-combinations thereof, for generating synthetic video advertisements. In some aspects, a computer-implemented method is provided for generating a synthetic video advertisement using a modular video advertisement template and input data describing a business. The method can be used to automatically select content and layout based on contextual metadata, business attributes, and/or advertisement goals.

In some aspects, the method can operate by obtaining input data that includes one or more business attributes associated with a business. The method can further include choosing, based on the one or more business attributes, a video advertisement template that includes a plurality of modular elements; producing, based on the one or more business attributes, textual content and image content for promoting the business; generating, based on the textual content, at least one audio track that is associated with one or more of the plurality of modular elements in the video advertisement template; and assembling a synthetic video advertisement by populating the plurality of modular elements in the video advertisement template with the at least one audio track and the image content.

In some aspects, a system is provided for generating a synthetic video advertisement. The system can include one or more memories and at least one processor coupled to at least one of the one or more memories and configured to: obtain input data that includes one or more business attributes associated with a business; choose, based on the one or more business attributes, a video advertisement template that includes a plurality of modular elements; produce, based on the one or more business attributes, textual content and image content for promoting the business; generate, based on the textual content, at least one audio track that is associated with one or more of the plurality of modular elements in the video advertisement template; and assemble a synthetic video advertisement by populating the plurality of modular elements in the video advertisement template with the at least one audio track and the image content.

In some aspects, a non-transitory computer-readable medium is provided for generating a synthetic video advertisement. The non-transitory computer-readable medium can have instructions stored thereon that, when executed by at least one computing device, cause the at least one computing device to: obtain input data that includes one or more business attributes associated with a business; choose, based on the one or more business attributes, a video advertisement template that includes a plurality of modular elements; produce, based on the one or more business attributes, textual content and image content for promoting the business; generate, based on the textual content, at least one audio track that is associated with one or more of the plurality of modular elements in the video advertisement template; and assemble a synthetic video advertisement by populating the plurality of modular elements in the video advertisement template with the at least one audio track and the image content.

### BRIEF DESCRIPTION OF THE FIGURES

The accompanying drawings are incorporated herein and form a part of the specification.

FIG. 1 illustrates a block diagram of an example video-generation system, according to some examples of the present disclosure.

FIG. 2 illustrates a block diagram of an example computing system, according to some examples of the present disclosure.

FIG. 3 is a diagram illustrating an example video-generation process, according to some examples of the present disclosure.

FIG. 4 is a diagram illustrating an example video-synthesis model, according to some examples of the present disclosure.

FIG. 5 is a conceptual illustration of an example frame of a synthetic video advertisement, according to some examples of the present disclosure.

FIG. 6 is a diagram illustrating a flowchart of an example method, according to some examples of the present disclosure.

FIG. 7 is a diagram illustrating an example system for generating a synthetic video advertisement, according to some examples of the present disclosure.

FIG. 8 is a diagram illustrating an example architecture for an AI services module used for generating a synthetic video advertisement, according to some examples of the present disclosure.

FIG. 9 is a diagram illustrating an example implementation of a polishing agent for performing aesthetic adjustments to a synthetic video advertisement, according to some examples of the present disclosure.

FIG. 10 is a diagram illustrating a flowchart of an example method for generating a synthetic video advertisement, according to some examples of the present disclosure.

FIG. 11 is a diagram illustrating a flowchart of another example method for generating a synthetic video advertisement, according to some examples of the present disclosure.

FIG. 12 is a diagram illustrating a flowchart of an example method for selecting a video advertisement template for a synthetic video advertisement, according to some examples of the present disclosure.

FIG. 13 is a diagram illustrating an example of a neural network architecture, according to some examples of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Generating compelling video advertisements traditionally requires significant creative effort, time, and production resources. Businesses, particularly small or localized ones, may lack the means to produce polished, high-quality video content tailored to their brand, audience, or promotional goals. As advertising platforms expand across digital channels and formats, there is a growing need for scalable systems that can automate the creation of engaging video advertisements without sacrificing customization or performance.

In some examples, the systems and methods disclosed herein address these needs by enabling the automated generation of synthetic video advertisements based on structured business input. These systems can dynamically assemble advertisement content using modular video templates and machine learning-based services for content generation, voice synthesis, media selection, and aesthetic refinement. For example, a business can submit a description of its services and desired promotional theme, and the system can generate a tailored video advertisement that includes an appropriate voiceover, text overlays, product imagery, and background visuals.

In some configurations, the system may employ decision logic—such as rule-based matrices or performance-informed models—to select an appropriate video template structure. The selected template can include modular elements, such as image frames, text regions, audio tracks, and transitional sequences, each of which can be independently populated or replaced. Based on input data, the system may also invoke AI services to generate promotional copy, synthesize audio narration, retrieve or transform media assets, and assemble a cohesive advertisement sequence.

In some implementations, a feedback engine can monitor the performance of deployed synthetic advertisements and update template selection or content generation parameters accordingly. For example, templates that historically perform well in a specific industry or demographic segment may be prioritized in future campaigns. Additionally, personalization may occur at runtime based on metadata such as audience location, time of day, or environmental conditions (e.g., weather), enabling dynamic adjustments to the visual or audio elements of the advertisement.

The disclosed technology thus provides a scalable and flexible framework for producing synthetic video advertisements that are personalized, performance-aware, and visually coherent. By leveraging modular templates, AI-generated content, and real-time targeting metadata, the system can efficiently produce customized video creatives suitable for delivery across a range of digital advertising platforms.

Various other features of the present technology are described hereinafter with reference to the accompanying figures.

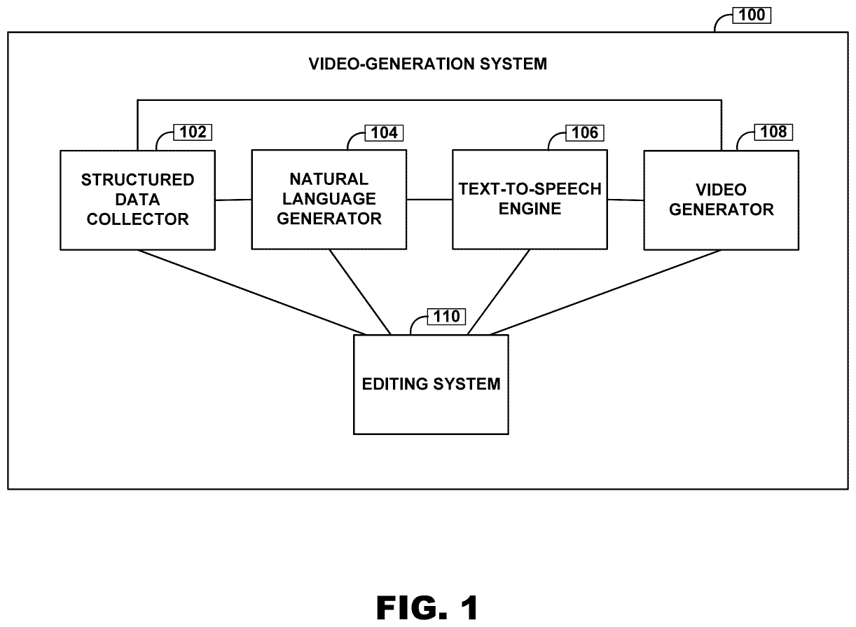

FIG. 1 is a simplified block diagram of an example video-generation system 100. The video-generation system 100 can include various components, such as a structured data collector 102, a natural language generator 104, a text-to-speech engine 106, a video generator 108, and/or an editing system 110.

The video-generation system 100 can also include one or more connection mechanisms that connect various components within the video-generation system 100. For example, the video-generation system 100 can include the connection mechanisms represented by lines connecting components of the video-generation system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, communication (e.g., a transmission or receipt of data) can be a direct or indirect communication.

The video-generation system 100 and/or components thereof can take the form of a computing system, an example of which is described below.

In some instances, the video-generation system 100 can include multiple instances of at least some of the described components.

In some cases, the video-generation system 100 can also include a content-presentation device (not shown) configured for presenting (e.g., displaying) videos. A content-presentation device can be or include a television set, a set-top box, a television set with an integrated set-top box, a video game console, a desktop computer, a laptop computer, a tablet computer, a mobile phone, a speaker (e.g., a soundbar mounted below the television set), or a home appliance, among other possibilities.

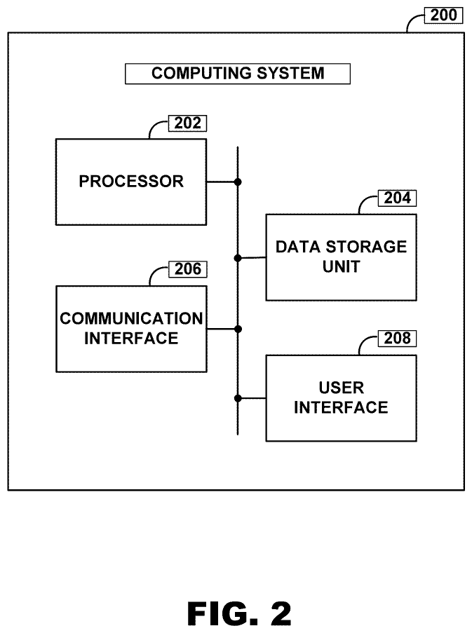

FIG. 2 is a simplified block diagram of an example computing system 200. The computing system 200 can be configured to perform and/or can perform one or more operations, such as the operations described in this disclosure. The computing system 200 can include various components, such as a processor 202, a data-storage unit 204, a communication interface 206, and/or a user interface 208.

The processor 202 can be or include a general-purpose processor (e.g., a microprocessor) and/or a special-purpose processor (e.g., a digital signal processor). The processor 202 can execute program instructions included in the data-storage unit 204 as described below.

The data-storage unit 204 can be or include one or more volatile, non-volatile, removable, and/or non-removable storage components, such as magnetic, optical, and/or flash storage, and/or can be integrated in whole or in part with the processor 202. Further, the data-storage unit 204 can be or include a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data-storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or WI-FI interface.

The user interface 208 can allow for interaction between the computing system 200 and a user of the computing system 200. As such, the user interface 208 can be or include an input component such as a keyboard, a mouse, a remote controller, a microphone, and/or a touch-sensitive panel. The user interface 208 can also be or include an output component such as a display device (which, for example, can be combined with a touch-sensitive panel) and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, for instance.

As noted above, the video-generation system 100 and/or components thereof can take the form of a computing system, such as the computing system 200. In some cases, some or all these entities can take the form of a more specific type of computing system, such as a content-presentation device.

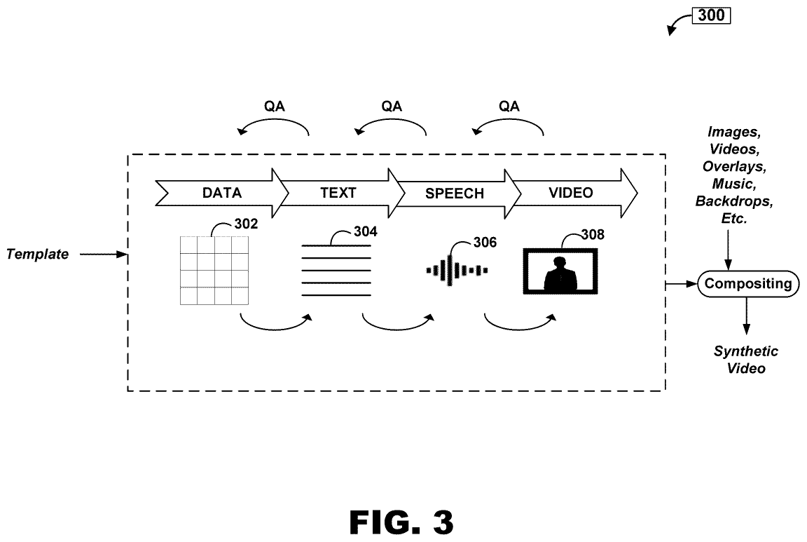

The video-generation system 100 and/or components thereof can be configured to perform and/or can perform one or more operations. Examples of these operations and related features will now be described with reference to FIGS. 3-6.

To begin, the structured data collector 102 or other component of the video-generation system 100 can obtain a set of one or more user attributes for a user of a content-presentation device.

To obtain the set of user attributes for the user, for example, the structured data collector 102 can access a user profile stored in local memory of the content-presentation device or stored in other memory in the video-generation system 100, with the user profile including the set of user attributes. The structured data collector 102 can also obtain the set of user attributes by receiving data from a computing system, with the data being input by a user via a user interface (e.g., a keyboard and/or microphone) of the computing system, such as a series of user inputs received to establish a user profile that includes the set of user attributes.

The set of user attributes can include a name of the user, a geographic area of the user (e.g., a current country, state, county, and/or address of the user), an employer of the user, a race and ethnicity of the user, an age of the user, a gender of the user, a marital status of the user, a salary of the user, a user-preferred language (e.g., English, Spanish, Japanese), a user-preferred secondary language, a search history of the user, a description or list of user interests/hobbies, a description or list of user-preferred products, a description or list of user-preferred services, a list of products or services purchased by the user, a user-preferred travel destination, a user-preferred spokesperson (e.g., a celebrity or other individual), a physical attribute of the user (e.g., skin color, hair color, body type, etc.), a user-preferred video content genre, and/or a user-preferred music genre or artist, among other possibilities. The set of user attributes can also include identifiers of products, services, people, places, things, etc., or characteristics thereof, that the user does not want to be shown in targeted advertisements.

In some implementations, obtaining the set of user attributes can involve receiving a content consumption history of the user, which can be stored in, and accessed from, memory and, in some cases, tracked by the video-generation system 100. A content consumption history of the user can take the form of data indicating media content (e.g., video, music) that the user has played out using the content-presentation device or other content-presentation devices that are communicatively coupled to the video-generation system 100 (e.g., a smartphone or television that is on the same local network as the content-presentation device). Such media content can include movies, television shows, music, podcasts, and the like. The content consumption history can also include metadata identifying other information about the media content that the user played out, such as a list of actors, directors, and/or musical artists associated with the media content. Further, in some cases, the content consumption history of the user can include web browsing data, such as a list of advertisements that the user has searched for or clicked on during web sessions and any product/service metadata associated therewith.

Having received the content consumption history, the structured data collector 102 can analyze the content consumption history to determine one or more user attributes to include in the set of user attributes. For example, if the user has watched a threshold quantity of movies starring a particular actor and/or watched content starring that particular actor for a threshold amount of time, the structured data collector 102 can determine the particular actor to be a user-preferred spokesperson for an advertisement.

In some implementations, obtaining the set of user attributes can involve receiving social media data for the user, which can be stored in, and accessed from, memory and, in some cases, tracked by the video-generation system 100. In some cases, the social media data can take the form of or be included in the user profile described above, or can be separate from the user profile. The social media data can include any user information specified in any one or more of the user's social media profiles. Further, in some cases, the social media data can include a social media content consumption history of the user, which can include, for instance, advertisements viewed on or otherwise accessed via social media platforms and posts viewed via social media platforms. In some cases, the content consumption history can include social media data.

Having received the social media data, the structured data collector 102 can analyze the social media data to determine one or more user attributes to include in the set of user attributes, such as in the same way user attributes are determined using the content consumption history.

In some implementations, a user profile specifying the set of user attributes can be created at least in part using the content consumption history and/or the social media data of the user.

In line with the present disclosure, any one or more user attributes of the set of user attributes described above can be used to personalize advertisement content to the user, as will be described in more detail below.

The structured data collector 102 can obtain structured data based at least in part on the obtained set of user attributes. As noted above, structured data includes data that is in a standardized format having a well-defined structure such that the format and meaning of the data is explicitly understood. Examples of structured data include sports box scores, weather forecasts, financial information, real estate records, entertainment summaries, images of products or services, product or service descriptions, other types of images (e.g., stock images, background images, etc.), and other forms of text (e.g., descriptions of content depicted in images), among other possibilities.

In some cases, structured data can be tagged/annotated with various parameters including target demographics (e.g., age, gender, marital status, race, etc.) with which the structured data is associated, product information (e.g., corporation, brand, description, image, price, availability, condition), service information (e.g., corporation, description, price, availability, images), geographic information, and more. As such, the structured data collector 102 can use the set of user attributes as search queries for structural data and compare user attributes from the set of user attributes with the structural data parameters and select structural data having parameters that match one or more of the user attributes. For example, the structured data collector 102 can select one or more images and text having parameters that match one or more user attributers of the set of user attributes, such as one or more images of the user-preferred product or the user-preferred service. In some cases, the parameters can take the form of keywords.

In some examples, the structured data collector 102 can obtain structured data from a database. The database can store records of structured data. The records may be organized by subject matter and date, for instance.

Additionally or alternatively, the structured data collector 102 can extract structured data through data scraping. For instance, the structured data collector 102 can use web scraping, web harvesting, and/or web data extraction to extract structured data from websites.

The structured data collector 102 can also obtain structured data by receiving data from a computing system, with the data being input by a user via a user interface (e.g., a keyboard and/or microphone) of the computing system. The data can take the form of keywords to assist with searching for structured data that is tagged with such keywords, or can take the form of the structured data itself, such as in the form of images and/or text.

FIG. 3 illustrates the role of such structured data in the video-generation process. More specifically, FIG. 3 is a diagram 300 of an example video-generation process. As shown in FIG. 3, structured data 302 is obtained as input for the video-generation process.

In some implementations, the set of user attributes can be used to select an advertisement template from a plurality (e.g., hundreds or thousands) of advertisement templates stored in memory. To facilitate this, the video-generation system 100 can store or otherwise have access to mapping data that maps each of a plurality of advertisement templates with a corresponding user attribute (or attributes). These advertisement templates can include templates for a certain types of products (e.g., a template for a healthcare product versus a template for a food product), certain types of services (e.g., a template for car repair), or other types of people, places, or things being advertised (e.g., a template for a sports team). These advertisement templates can also include templates of varying duration (e.g., a template for a 30-second advertisement versus a template for a 15-second advertisement).

As an example of template selection, the structured data collector 102 can determine from the set of user attributes that the user is in a particular demographic (e.g., a thirty-five year old male) and/or has a specified interest in sports, and can thus select an advertisement template for a sports-related product. As another example, the structured data collector 102 can determine from the set of user attributes that the user lives in an urban area and can thus select an advertisement template that has images or footage of urban environments. As yet another example, the set of user attributes can specify a user-preferred tone (e.g., happy, somber, angry, etc.) and thus the structured data collector 102 can use the mapping data to select an advertisement template having that particular tone. Other examples are possible as well.

A given advertisement template can be or include pre-existing video (e.g., synthetic video or pre-recorded video) having various types of placeholders in which images, text, audio, human (e.g., pre-recorded video of a human, or synthetically-generated rendering of a human), or other information can be inserted.

As an example, the advertisement template can include one or more temporal placeholders, such as a temporal portion (e.g., two seconds worth of frames) left empty of a larger sequence of frames that make up the advertisement.

As another example, the advertisement template can include one or more spatial placeholders, such as a region of one or more frames left empty (e.g., a backdrop behind synthetically-generated actors) or a designated location for an overlay, in which images and/or text can be placed.

As yet another example, the advertisement template can include one or more audio placeholders for sound effects and/or background music for the advertisement.

As yet another example, the advertisement template can include one or more script placeholders, such as placeholders in which to insert a product/service name or description.

In some implementations, when an advertisement template has been selected, the set of user attributes can also be used to select the structured data to be inserted into the template. As an example, the structured data collector 102 can determine from the set of user attributes that the user is in a particular demographic (e.g., a thirty-five year old male) and lives in a particular location (e.g., New York City), and can thus select an advertisement template for a sports-related product, and obtain/insert images, video, text, etc. for a New York City sports team in the advertisement template.

To facilitate obtaining structured data for insertion into a selected advertisement template, the template might include a set of data fields for which corresponding images and/or text is/are desired.

In some examples, the template can include an identifier that specifies a source of the structured data (e.g., a website). With this approach, the structured data collector 102 can use the identifier to extract the structured data that is appropriate for the template.

Other factors can be used to obtain the structured data as well, in addition to the set of user attributes. As an example, the structured data collector 102 can determine and consider a time of year or current weather associated with a known address or other geographic area associated with the user. For instance, if the user lives in New York City and the structured data collector 102 determines that it is currently the winter season in New York City, the structured data collector 102 can collect images and text for winter-themed products or services, such as warm clothes, heating appliances, holiday gifts, etc., and/or can select a background image or video for the advertisement that is associated with the time of year and weather (e.g., a background in which it is snowing outside). The time of year considered can also extend to a time of year for a season for a type of sports. For example, if the set of user attributes specifies a user-preferred sports team and that team's sport is currently in-season, the structured data collector 102 can collect images and text associated with that sports team. Additionally or alternatively, the structured data collector 102 can determine and consider a time of day (e.g., morning, afternoon, night), and search for structured data based at least in part on the time of day.

In some implementations, during the process of obtaining the structured data, or during the process of generating the synthetic video described in more detail below, the video-generation system 100 can use the set of user attributes to determine a spokesperson (i.e., a human, or talking animal/object, depicted in the synthetic video that speaks synthesized speech in accordance with the targeted advertisement) to be included in the synthetic video. For example, if the set of user attributes specifies a set of user-preferred physical characteristics (e.g., hair, skin color, height, weight), the video-generation system 100 can use those physical characteristics to select a set of characteristics of a spokesperson according to which to render the spokesperson in the synthetic video. As another example, if the set of user attributes indicates a particular celebrity as a user-preferred spokesperson (e.g., based on the user having watched a threshold quantity of movies starring a particular actor), the video-generation system 100 can generate a synthetic version of that celebrity for the advertisement or can generate a spokesperson having one or more of the same physical characteristics as that celebrity. Other examples are possible as well.

In line with the discussion above, the natural language generator 104 or other component of the video-generation system 100 can determine a textual description of the structured data based at least in part on the obtained set of user attributes.

As an example, the natural language generator 104 or other component of the video-generation system 100 can receive a predetermined script for an advertisement and insert one or more of the user attributes into the script. For instance, the script can include one or more placeholders including the user's name and occupation, which can be filled in using the set of user attributes. As a specific example, the script can begin with the language “Hello, [INSERT NAME],” where “[INSERT NAME]” is a placeholder in which to insert the user's name from the set of user attributes.

As another example, the natural language generator 104 or other component of the video-generation system 100 can use at least one of the user attributes of the set to select a predetermined script or portion of a script stored in memory, using mapping data that maps each of a plurality of different user attributes, or a respective combination of multiple user attributes, to a corresponding script or portion of a script. For instance, for a female user below age thirteen, a script or portion of a script can be chosen that has words that are more commonly found in advertisements for adolescent or preadolescent females.

The act of determining the textual description of the structured data based on the set of user attributes can involve generating, using the natural language generator 104, a textual description of the structured data that includes a textual representation of at least one of the user attributes from the set of user attributes. In some cases, the textual description of the structured data is or includes a narrative advertising a product or service related to the structural data, such as a user-preferred product or service specified in the set of user attributes. For example, in situations where the structured data collector 102 selects text having parameters that match one or more user attributes of the set of user attributes, such as descriptions or names of the user-preferred product or the user-preferred service, the natural language generator 104 can determine a textual description of the structured data that includes the selected text.

In some cases, the natural language generator 104 can refer to the set of user attributes and, if the set of user attributes includes a user-preferred language, the natural language generator 104 can generate the textual description in the user-preferred language, using vocabulary and grammar from that language.

FIG. 3 depicts the textual description 304 of the structured data 302. In some cases, the natural language generator 104 can include one or machine learning models that produce human-readable text (e.g., sentences) in one or more languages using structured data.

One example of a natural language generator is the GPT-3 language model developed by OpenAI. A similar example of a natural language generator is Wu-Dao. Other examples include Automated Insight's Wordsmith and the Washington Post's Heliograf.

In some cases, the natural language generator can include a deep learning-based synthesis model that uses deep neural networks (DNNs) to produce a script for an advertisement. The deep learning-based synthesis model can be trained using training data that includes scripts for existing advertisements. Using deep learning, the video-generation system 100 can create scripts that accurately resemble the cadence, structure, and vocabulary found in advertisements and that target specific audiences and user attributes.

In some examples, the natural language generator 104 generates the textual description 304 using a multi-stage approach. In a first stage, the natural language generator 104 interprets the structured data 302. Interpreting the structured data 302 can involve identifying a pattern in the structured data 302. For instance, structured data can identify a product name and user rating for the product. During the interpreting stage, the natural language generator can identify the product name and rating.

A next stage can include document planning. During the document planning stage, the natural language generator 104 organizes features in the structured data to create a narrative. In some cases, the natural language generator 104 uses rule-based templates to pair identified features with targeted sequences. For instance, in the case of a product for sale, the narrative may include an opening paragraph describing a common problem for which the product was designed to solve, as well as other paragraphs describing the product, its cost, and other information.

Additional stages can include a sentence aggregation stage, where multiple sentences can be aggregated together, and a grammaticalization stage that validates the generated text according to syntax, morphology, and orthography rules.

In some examples, the natural language generator 104 refines and improves the generated text using back translation and/or paraphrasing. These techniques can improve the readability of the textual description 304.

Other factors can be used to determine the textual description as well, in addition to the set of user attributes, such as the determined time of year and/or time of day. As an example, the natural language generator 104 can use the time of year to generate, or select existing, textual descriptions of structured data obtained based on the structural data's relation to the time of year.

The editing system 110 can include a computing system that allows a user to review the textual description 304 generated by the natural language generator 104 as part of a quality assurance process. For instance, the editing system 110 can present the textual description 304 on a display, and a user of the editing system 110 can approve or reject the textual description 304 using a user interface of the editing system 110.

In line with the discussion above, the text-to-speech engine 106 can transform the textual description 304 into synthesized speech 306. The text-to-speech engine 106 can take any of a variety of forms depending on the desired implementation.

By way of example, the text-to-speech engine 106 can include a deep learning-based synthesis model that uses deep neural networks (DNNs) to produce artificial speech from text. The deep learning-based synthesis model can be trained using training data that includes recorded speech and the associated input text. Examples of deep learning-based synthesis models include WaveNet developed by DeepMind, Tacotron developed by Google, and VoiceLoop developed by Facebook.

In situations where the natural language generator 104 generates the textual description 304 in a user-preferred language specified by the set of user attributes, the text-to-speech engine 106 can be configured to transform the textual description into synthesized speech that includes a pronunciation and accent associated with the user-preferred language.

In some examples, the text-to-speech engine 106 obtains a speech sample for a speaker and transforms the textual description 304 into the synthesized speech 306 using the speech sample. For instance, a deep learning-based synthesis model can transfer learning from speaker verification to achieve text-to-speech synthesis. More specifically, the deep learning-based synthesis model can use pre-trained speaker verification models as speaker encoders to extract speaker embeddings from a speech sample for a speaker. Extracting the speaker embeddings allows the deep learning-based synthesis model to learn the style and characteristics of the speaker, so that the synthesized speech output by the deep learning-based synthesis model sounds like the speaker. The speech sample can be audio extracted from a sample video.

The editing system 110 can include a computing system that allows a user to review the synthesized speech 306 generated by the text-to-speech engine 106 as part of a quality assurance process. For instance, the editing system 110 can playback the synthesized speech 306, and a user of the editing system 110 can approve or reject the textual description 304 using a user interface of the editing system 110.

In line with the discussion above, the video generator 108 uses the synthesized speech 306 to generate, for display by the content-presentation device of the user, a synthetic video 308 of a targeted advertisement including the synthesized speech 306. The synthetic video 308 can also include the structural data discussed above, such as one or more images, text, etc. associated with the product or service being advertised. Various types of synthetic videos 308 are contemplated. The complexity of the video generator 108 can vary depending on the desired implementation.

Upon generating the synthetic video 308, the video generator 108 can transmit the synthetic video 308 to the content-presentation device for display. Alternatively, if the video-generation system 100 is a computing system within the content-presentation device, the video generator 108 can instruct a display device of the content-presentation device to display the synthetic video 308.

In some examples, the synthetic video 308 includes one or more images and an accompanying audio track comprising the synthesized speech 306. For instance, the synthetic video 308 can include one or more images of a soda can, and the synthesized speech 306 can explain the appeal of the type of soda being advertised. Alternatively, the synthetic video 308 can include one or more images and/or video clips related to a travel destination, and the synthesized speech 306 can explain details about the appeal of the travel destination. The video generator 108 can generate these types of videos by combining the synthesized speech 306 with images, videos, overlays, music, and/or backdrops. For instance, an editor can use editing system 110 to select images, videos, overlays, music, and/or backdrops for different parts of the synthetic video 308, and the video generator 108 can render a video having the appropriate features based on the selection(s).

In other examples, the synthetic video 308 can depict a human (e.g., also referred to as spokesperson, as noted above) speaking the synthesized speech 306. In this implementation, the video generator 108 can generate the synthetic video 308 using a sample video of the human speaking and a video-synthesis model. The human speaking in the sample video can be a real human or a computer-generated (e.g., virtual) human. The video generator 108 can use the video-synthesis model to determine facial expressions for the human while the human speaks the synthesized speech. Additionally, the video generator 108 can use the video-synthesis model to determine facial expressions for the human while the human speaks the synthesized speech.

In some examples, the video-synthesis model is a temporal generative adversarial network (GAN). For instance, the video-synthesis model can include multiple discriminators that cooperate to perform a spatial-temporal integration of a sample video of the human and the synthesized speech to form the synthetic video 308, which looks as if the human had spoken the textual description 304 in a live, real camera recording.

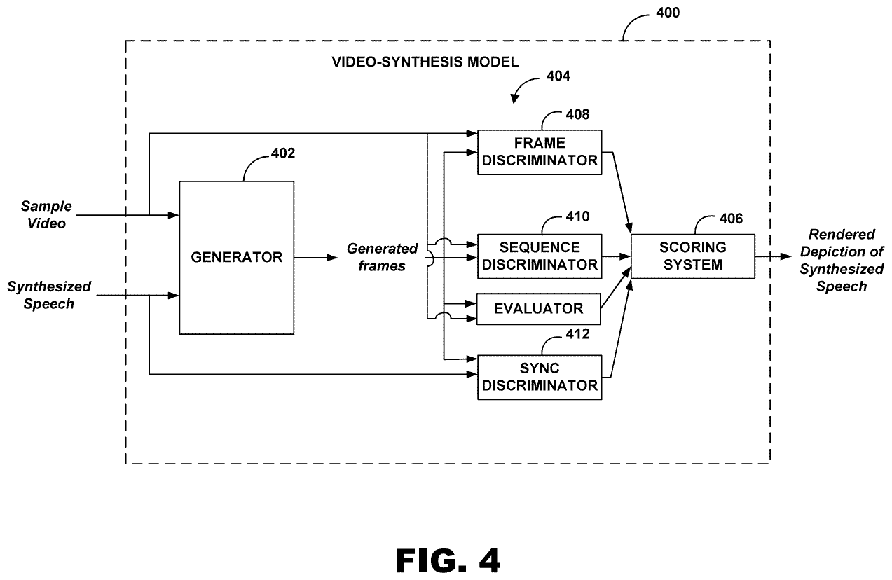

FIG. 4 is a simplified block diagram of an example video-synthesis model 400. As shown in FIG. 4, the video-synthesis model includes a generator 402, an ensemble of discriminators 404, and a scoring system 406.

The generator 402 receives as input a sample video of a human speaking and synthesized speech. The generator 402 has an encoder-decoder structure and includes a content encoder, identity encoder, and a noise generator, and frame decoder. In one example, the human's identity (e.g., facial expressions and, optionally, gestures) is encoded by the identity encoder using a first convolutional neural network (CNN) that converts an image from the sample video into a first latent space representation. Additionally, an audio frame (e.g., 0.2 seconds) of the synthesized speech is encoded by the content encoder using a second CNN that converts the audio frame into a second latent space representation. The frame decoder then combines the first latent space representation, the second latent space representation, and noise generated by the noise generator into a latent representation for a generated frame. This process is repeated for different audio frames to generate multiple generated frames.

The ensemble of discriminators 404 include multiple discriminators that allow for generation of different aspects of videos. By way of example, as shown in FIG. 4, the ensemble of discriminators 404 includes a frame discriminator 408, a sequence discriminator 410, and a synchronization discriminator 412.

The frame discriminator 408 distinguishes between real and synthetic frames using adversarial training. For example, the frame discriminator 404 can include a CNN that determines, at a frame-level whether a generated frame, from the generator 402, is realistic in terms of facial expressions and, optionally, gestures. The frame discriminator 404 can be trained using frames from the sample video. The frame discriminator 408 can output a score indicative of whether a generated frame is realistic.

The sequence discriminator 410 determines whether a sequence of generated frames is real or synthetic using adversarial training. For example, the sequence discriminator 410 can include a CNN with spatial-temporal convolutions that extracts and analyzes movements across generated frames of the sequence. The sequence discriminator 410 can be trained using sequences of frames from the sample video. The sequence discriminator 410 can output a score indicative of whether a sequence of frames is realistic.

The ensemble of discriminators 404 can also include other types of discriminators that allow for generating other aspects at the frame or sequence of frames level.

Finally, the synchronization discriminator 412 determines whether the generated frames are in or out of synchronization with a corresponding portion of the synthesized speech. For example, the synchronization discriminator 412 can include an audio encoder that computes an audio embedding, a video encoder that computes a video embedding, and a distance calculator that computes a Euclidian distance between the embeddings as a measure of synchronization. The synchronization discriminator 412 can be trained using corresponding audio portions and sequences of frames from the sample video. The synchronization discriminator 412 can output a score indicative of whether the synchronization between the synthesized speech and the generated sequence of frames is realistic.

The scoring system 406 utilizes scores output by the ensemble of discriminators to determine whether to render the generated frames as a synthetic video. For instance, the scoring system 406 can be configured to determine a weighted average of scores about by the frame discriminator 408, the sequence discriminator 410, and the synchronization discriminator 412 and compare the weighted average to a threshold. Based on determining that the weighted average exceeds a threshold, the scoring system can output the generated frames as a depiction of the synthesized speech. Whereas, based on determining that the weighted average does not exceed the threshold, the scoring system can cause forgo outputting the generated frames and, optionally, continue to generate new frames in an effort to achieve a more realistic video. As such, in some examples, the scoring system 406 serves as a gatekeeper that regulates whether or not the generated frames look realistic enough to merit rendering a synthetic video using the generated frames.

Alternatively, the scoring system 406 can be configured to compare scores that are output by individual discriminators of the ensemble of discriminators 404 to respective thresholds. Upon determining that the scores output by each of the discriminators of the ensemble of discriminators 404 exceeds a respective threshold, the scoring system can output the generated frames as a depiction of the synthesized speech.

The output of the video-synthesis model 400 is a rendered depiction of the human in the sample video speaking the synthesized speech 306. In some examples, the video generator 108 combines the rendered depiction of the human speaking the synthesized speech 306 with images, videos, overlays, music, and/or backdrops. For instance, an editor can use editing system 110 to select images, videos, overlays, music, and/or backgrounds/backdrops for different parts of the synthetic video 308, and the video generator 108 can render a video having the appropriate features based on the selection(s). As one example, an editor can select a video snippet to be displayed (e.g., as an overlay or occupying the entire frame) between two instances of synthesized speech.

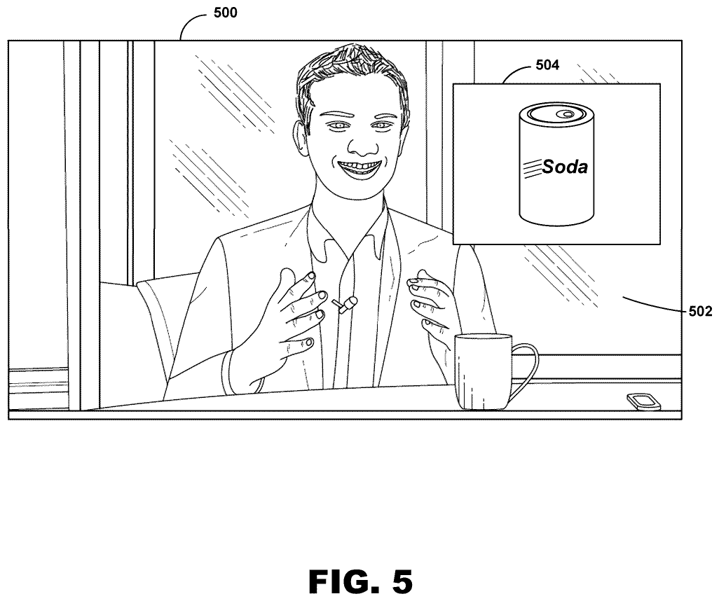

FIG. 5 conceptually illustrates an example frame 500 of a synthetic video advertisement. As shown in FIG. 5, the frame 500 depicts a human advertising soda. The frame 500 also includes a backdrop 502, an image 504 of a soda can, and other objects (e.g., a desk, mug, and cellular phone). The video-generation system 100 can generate the frame 500 of the synthetic video by using user attributes to obtain structured data for the soda and determine a textual description from the structured data, transforming the textual description into synthesized speech, and generating a rendering of a human speaking the synthesized speech.

In some examples, by generating the synthetic video using a video-synthesis model, such as the video-synthesis model 400, the frame of the synthetic video (and the other frames of the video) may be indistinguishable from reality. Further, by leveraging the structured data, the synthetic video can be produced in an efficient manner, decreasing the time and labor costs typically required in producing, editing, and publishing videos.

Furthermore, the use of user attributes enables the video-generation system 100 to efficiently tailor synthetic advertisements for a variety of different users, and in some cases having the same general synthetic advertisement modified in different ways depending on the target user. By way of example, in the context of the soda advertisement of FIG. 5, a first user might be an office worker that speaks Spanish as their first language, and so the synthetic speech spoken by the human in the synthetic video of the soda advertisement can be in Spanish. As another example, a second user might work at a factory and speak English as their first language, and so the backdrop 502 of the frame 500 (and of other frames) can be selected to depict a factory floor and the synthetic speech can be in English. As yet another example, a third user might speak Japanese as their first language, and so the synthetic speech spoken by the human in the synthetic video of the soda advertisement can be in Japanese. Other elements of the synthetic video, such as the clothing and/or appearance of the human can take different forms as well, depending on the user attributes. An advertisement targeted to a user who is an office worker can include a human in a suit and tie, whereas to target that advertisement to a user who is a factory worker, the human can be generated or modified to wear factory worker clothes.

In some cases, the act of generating a synthetic video of a target advertisement can involve modifying an existing synthetic video of the target advertisement in one or more ways, such as by changing a language of the synthetic speech, changing one or more images or text displayed, changing words in the script, etc.

In some implementations, the video-generation system 100 can also use the products or services present in structural data and advertised in synthetic advertisements as a basis for modifying one or more objects in a synthetically-generated program segment. For example, a synthetic video of a newscaster reporting the news can be generated with various ad breaks in which synthetic advertisements are generated and inserted. There may also be a mug on the desk in front of the newscaster. In a situation where a synthetic a car commercial for a specific car manufacturer is generated in the manner described above and inserted into one such ad break, the synthetic video of the newscaster can be modified such that the mug includes a logo for the car manufacturer of the preceding synthetic advertisement. Other examples are possible as well.

In some implementations, the video-generation system 100 can create or dynamically-adjust the synthetic advertisement based on the user's current environment. For example, if the video-generation system 100 estimates or determines the time of day at which the synthetic advertisement is being presented, the video-generation system 100 can select a background color to mirror or contrast an expected ambient light in the user's viewing environment that is associated with that time of day.

Additionally or alternatively, the video-generation system 100 can use a camera mounted on the content-presentation device and/or an ambient light sensor to detect an ambient light that is currently present in the viewing environment and use the detected ambient light color and brightness to select a background or other visual element of the synthetic advertisement, and can further adjust that background or other visual element if a change in the ambient light is detected (e.g., due to a user closing blinds, so as to reduce the amount of sunlight in the viewing environment).

Further, in some implementations, the video-generation system 100 can be configured to blend a background of an image of the structured data (e.g., an image of the advertised product or service) with a background of the synthetic advertisement. For example, the structured data might include an image of a person wearing a sweater, selected based on user attributes that indicate the target user is living in an area in which it is winter and the temperature is cold. The image might have a solid, light grey background, and the video-generation system 100 can sample one or more pixels from that background and select or generate a background for an entire frame or series of frames of the synthetic advertisement that has the same solid, light grey color. Other examples are possible as well.

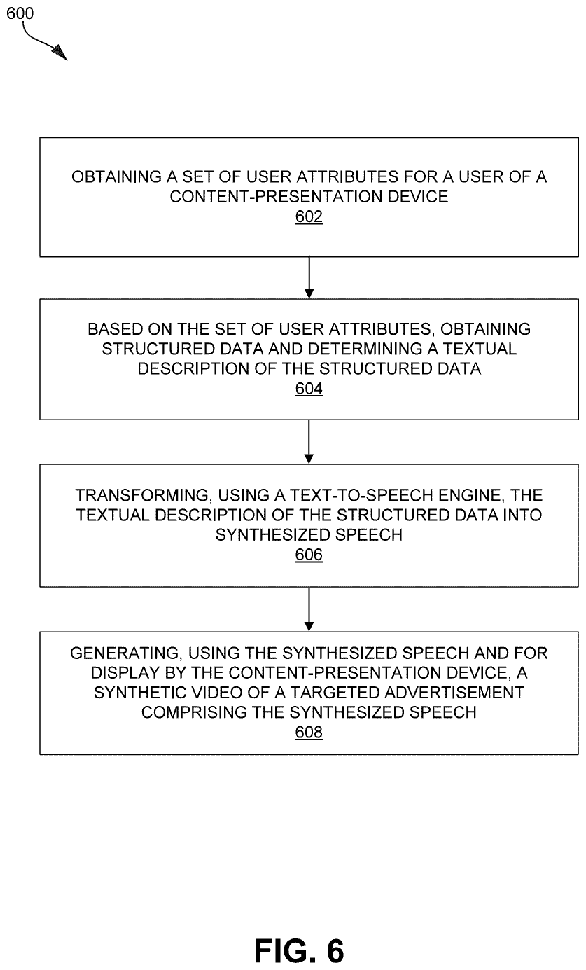

FIG. 6 is a flow chart illustrating an example method 600. The method 600 can be carried out by a video-generation system, such as the video-generation system 100, or more generally, by a computing system. At block 602, the method 600 includes obtaining a set of user attributes for a user of a content-presentation device. At block 604, the method 600 includes based on the set of user attributes, obtaining structured data and determining a textual description of the structured data. At block 606, the method 600 includes transforming, using a text-to-speech engine, the textual description of the structured data into synthesized speech. At block 608, the method 600 includes generating, using the synthesized speech and for display by the content-presentation device, a synthetic video of a targeted advertisement comprising the synthesized speech.

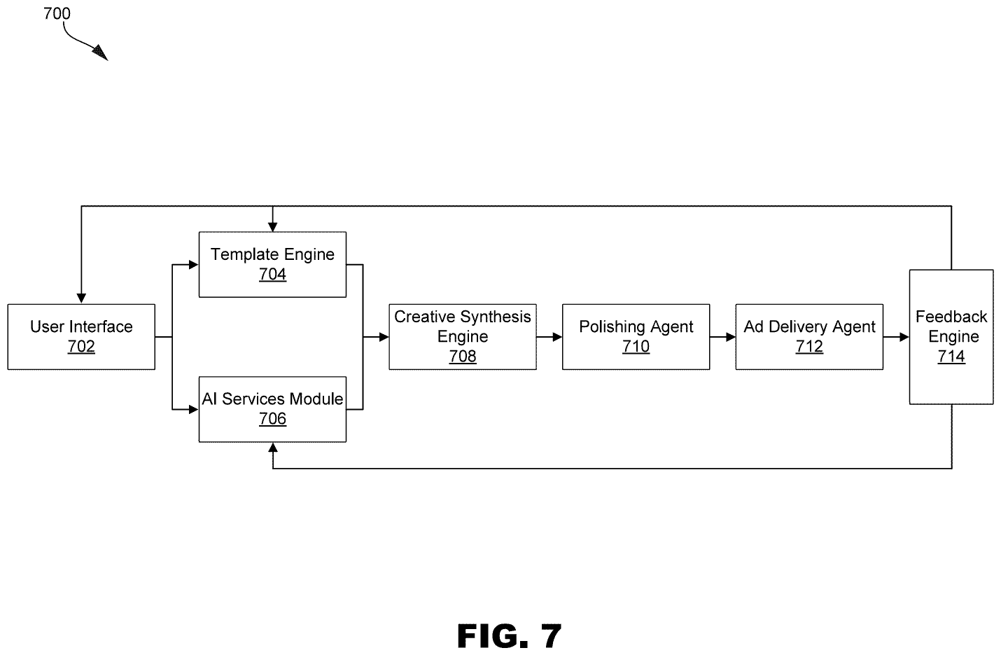

FIG. 7 illustrates a system 700 that may be used to generate a synthetic video advertisement. In some configurations, the system 700 may include a user interface 702, a template engine 704, an AI services module 706, a creative synthesis engine 708, a polishing agent 710, an ad delivery agent 712, and a feedback engine 714. In various implementations, these components may be distributed across one or more devices or executed within a shared computing environment, such as a cloud-based content generation platform. In some cases, each component within system 700 may communicate via one or more APIs or shared memory structures, and system 700 may operate in batch mode, on-demand mode, and/or as part of an interactive content generation flow.

In some aspects, the user interface 702 may be used to obtain input data from a business. In some examples, the input data may be provided directly by the business user or automatically inferred from associated online sources. In some cases, the input data can include one or more business attributes. In some examples, the business attributes can include a product type (e.g., “organic soap,” “diet soda,” etc.) and/or a service type (e.g., “landscaping service,” “luxury vacation rental,” etc.). In some instances, the business attributes can include an associated industry (e.g., “personal care”, “automotive repair”) as well as relevant parties in the industry (e.g., competitors, suppliers, etc.)

In some aspects, the input data obtained via user interface 702 can include a promotional goal (e.g., “awareness”, “local store visit”, or “holiday sale”). In some examples, the input data may indicate or may be used to infer a recurrence that is associated with a product or service. For instance, the system may detect a promotional sale that is being offered for one weekend. In another example, legal services associated with an automobile accident can be associated with a non-repetitive service offering. In another example, house cleaning services can be associated with a recurring service (e.g., weekly cleaning). In some cases, inferred recurrence patterns may be used to influence template structure and/or copywriting tone. Additionally, in some instances, certain temporal or event-based cues (e.g., a “back-to-school” period or “black Friday weekend”) may be automatically recognized.

In some cases, the input data may include contextual parameters such as a geographic region (e.g., “Miami, Florida”), time of day (e.g., “evening slots”), audience segment (e.g., “retired homeowners”), or viewing environment (e.g., connected TV vs. mobile). In some aspects, the user interface 702 may present a form with guided fields, a multi-step wizard, and/or a conversational chatbot. In some cases, the user interface 702 may pre-fill data by querying a business's website or social media page. In some implementations, the user interface 702 may also suggest visual or tonal presets based on prior campaign results from similar businesses or regions.

In some configurations, the template engine 704 may be used to select or generate a video advertisement template based on the input data. However, in some cases, the system 700 may bypass template engine 704 and generate the synthetic video advertisement without selecting or instantiating a predefined template. In such cases, downstream components such as the creative synthesis engine 708 may infer layout and timing based on content characteristics, tone classification, or rendering heuristics. As used herein, a video advertisement template refers to a structured framework that can be used to define the layout, sequence, timing, and content regions of a video advertisement. In some aspects, a template may include a plurality of modular elements such as text regions, image regions, audio regions, animated transitions, and/or call-to-action regions. In some examples, each modular element may be instantiated, populated, replaced, or removed independently of one another, enabling a flexible and composable ad architecture.

In some cases, each modular element within the template structure may define or be associated with one or more constraints. These constraints may include, but are not limited to: (i) layout constraints (e.g., alignment, content region size, spatial dimensions, or aspect ratio, as reflected in layout metadata); (ii) timing constraints (e.g., scene durations, transition timing, or voiceover alignment as reflected in timing metadata); (iii) content constraints (e.g., text length, image resolution, or voice style requirements); (iv) stylistic constraints (e.g., color grading, motion pacing, music tone, etc.); and/or (v) any other structural or semantic requirements. In some instances, these constraints may be propagated to one or more components within system 700 to ensure conformity—for example, template parameters may be passed to the AI services module 706, the creative synthesis engine 708, or other downstream modules.

In some cases, the template engine 704 can select a template from a predefined template library based on the input data. For example, a restaurant in a tourist area may be matched to a 15-second “high-energy hospitality” template with slots for exterior shots, menu highlights, and a customer testimonial. In other cases, the template engine 704 may generate a new template dynamically, such as by combining an “intro headline” module with a “benefit-carousel” middle section and a “call-to-action with logo animation” outro. In some configurations, templates selected or generated by the template engine 704 may also encode timing constraints (e.g., scene duration), text animation styles, and voiceover alignment logic.

In some implementations, the selection or generation of the video advertisement template may be guided by a multi-attribute decision matrix or rule engine. For instance, a matrix can be used to map combinations of business attributes (e.g., product or service type, recurrence pattern, urgency level) and contextual parameters (e.g., target audience profile, industry category) to corresponding template types. In some cases, this mapping can be implemented using a static rule engine, a decision matrix, a learned model (e.g., trained on historical campaign data), and/or any other suitable technique. In one illustrative example, a recurring home service with high urgency targeting the “home and garden” category may be mapped to a 15-second voiceover-driven template with an urgent call-to-action. In another example, a one-time retail product with low urgency may be mapped to a visually focused template with product imagery and a price overlay.

In some cases, the matrix for selecting the video advertisement template may include weighted factors derived from industry-specific heuristics (e.g., high animation tolerance in gaming, testimonial emphasis in medical services, etc.). In some implementations, the matrix may also incorporate localization preferences, such that different geographic regions or cultural segments are mapped to different template variants. For example, a restaurant in Southern California may be matched with a template emphasizing outdoor dining and bright color palettes, while a counterpart in New England may emphasize cozy interior shots and subdued tones.

In some cases, the matrix selection logic implemented by template engine 704 may also incorporate historical performance data associated with previously deployed synthetic ads. For example, the system 700 may rank template types based on which formats historically performed best in similar industry segments and viewing environments. In one illustrative implementation, the matrix may include logic to evaluate whether a high-performing ad occurred in a first-impression context (e.g., new viewer) or for a familiar brand. In some cases, the template engine 704 may assign higher value to templates associated with first-impression success, under the premise that positive initial exposure is more difficult to achieve. In some configurations, feedback signals from feedback engine 714 may be incorporated into the template ranking logic, as further described below. In some implementations, the selection logic may consult an indexed similarity graph of past campaigns to identify layout styles that maximized engagement under matching conditions.

In some configurations, the matrix may be implemented using static rules, heuristics, or adaptive models trained on historical performance data. In some cases, the matrix may return a ranked list of candidate templates or generate a composite template structure based on weighted inputs. In some implementations, templates selected or generated by the template engine 704 may also encode timing constraints (e.g., scene duration), text animation styles, and voiceover alignment logic.

In some examples, the AI services module 706 may be used to produce content for populating the selected video advertisement template. In some aspects, the AI services module 706 may include one or more subcomponents that can each be configured to perform a distinct generation or enhancement task. In some configurations, the AI services module 706 may adapt content generation based on localization or audience metadata. For example, the language model may be prompted to generate region-specific messaging (e.g., “Beat the Miami heat with . . . ” vs. “Stay warm this winter in Boston with . . . ”) or cultural references based on the target audience segment.

In some configurations, the AI services module 706 may include a web scraping component that can be configured to extract structured data from a business's website, online store, or third-party business listing. In one illustrative example, the web scraper may be used to retrieve product names, prices, store hours, service descriptions, and/or customer testimonials. In some cases, the scraped content may then be filtered, ranked, or deduplicated prior to further processing. In some implementations, the web scraper may be guided by semantic cues from the selected template (e.g., prioritize pricing info if the layout includes a price overlay region). In some aspects, the web scraper may apply content-specific extraction strategies based on known data structures within website platforms (e.g., the system 700 may use pre-trained selectors or Document Object Model (DOM) pattern matchers to identify product galleries, pricing tables, call-to-action blocks, etc.).

In some implementations, the AI services module 706 may include a language model component, such as a transformer-based text generation model. This component may be used to generate promotional text that fits a specified tone or narrative goal. For instance, given input data describing an eco-friendly laundry detergent, the language model may generate a tagline such as “Tough on stains. Kind to the planet.” In some configurations, the language model may also tailor lexical choice to match regional preferences or cultural norms. For example, in a beverage advertisement, the system may choose the term “soda” for viewers in the Northeastern United States and “pop” for viewers in the Midwest, based on contextual metadata such as geographic region or dialect cues.

In some cases, additional prompts may be used to create benefit statements, persuasive descriptions, and/or customized calls to action. In some implementations, the language model may be tuned or selected based on vertical domain (e.g., retail, finance, wellness). In some implementations, tone classification results may also be passed to downstream layout engines to guide stylistic presentation of text. For instance, a classification indicating a “reassuring” tone may result in selection of softer colors and rounded fonts, while an “energetic” tone may result in bold fonts and kinetic animations

In some aspects, the AI services module 706 may also include a text-to-speech (TTS) engine configured to synthesize audio narration based on the generated textual content and/or the input data. In some examples, the TTS engine may offer a range of selectable voice models differing in gender, tone, language, accent, or regional variation. For instance, a business located in Atlanta may use a Southern-accented female voice with a warm tone, while a Manhattan-based startup may choose a fast-paced neutral-male voice with high energy. In some cases, voice model selection may be based on business attributes, user input, or audience targeting rules.

In some examples, the AI services module 706 may further include a media content selector that can be configured to retrieve or rank media (e.g., image, video, audio) assets for use in the advertisement. In some configurations, the media content may be selected from a stock media library based on one or more business attributes (e.g., industry, product category), or retrieved directly from the business website or user-uploaded files. For example, if the business offers handcrafted candles, the system may select stock images of cozy home environments or use uploaded product photos featuring the business's own packaging. In some cases, the media content may be filtered or resized automatically to match the spatial and/or temporal requirements of the selected template.

In some implementations, the AI services module 706 may include a media synthesis component, such as an image animation module or image-to-video generator. This component may transform static product images into short video clips using techniques like pan, zoom, or transition effects. In one illustrative example, a still image of a hair serum bottle may be animated with a slow upward pan and gentle sparkle overlay to create a five-second clip suitable for use in a template segment. In some configurations, the system may leverage external services or proprietary models trained to convert e-commerce images into marketing-ready video content.

In some cases, the media synthesis component may also be configured to synthesize new media content, including generated images or audio segments. For instance, the system may generate a stylized background image based on a product description or synthesize a brief audio cue (e.g., a jingle, product sound effect, or background ambiance) based on the tone or category of the advertisement. These synthesized elements may be used to supplement, enhance, or replace business-provided or stock media assets in order to improve visual and auditory cohesion within the final video advertisement.

In addition to the components described above, the AI services module 706 may also include a prompt orchestration mechanism (e.g., prompt controller). In some configurations, the prompt controller may be used to coordinate generation and refinement. For example, a prompt controller may synthesize business-specific instructions, template constraints, and/or tone guidance into structured prompts that can be passed to a language model, voice generation engine, and/or media synthesis tools. In some configurations, the prompt controller may maintain a contextual state store to ensure consistent tone or messaging across content elements. For example, a value proposition extracted from the product description may be reused across the intro text, voiceover, and call-to-action template elements via shared prompt variables. In some cases, the prompt controller may also encode localization instructions, such as language, cultural tone, or regional references, which may be derived from contextual parameters or feedback signals.

In some implementations, the creative synthesis engine 708 may receive the selected template (e.g., from the template engine 704) along with the generated or retrieved content (e.g., from AI services module 706). In some aspects, the creative synthesis engine 708 can use this information to assemble a synthetic video advertisement (e.g., based on type compatibility and template structure). For example, a generated tagline may be placed into a headline text region, while a product image scraped from the business website may be slotted into an image placeholder associated with a product showcase segment. If a particular modular element does not have associated content, the creative synthesis module 708 may omit that element or populate it using fallback assets, such as default imagery or templated slogans. In some examples, this modular population framework enables individualized control over content placement and facilitates selective regeneration workflows

In some cases, the creative synthesis engine 708 may align visual transitions to audio cadence or apply text animation presets (e.g., fade-in, slide-up) for emphasis. In some implementations, the layout of textual elements—such as their color, font style, screen position, and/or animation style—can be selected using a machine learning model trained to match these attributes to the tone or emotional context of the advertisement. For example, a somber ad tone may result in muted text colors and minimal animations, whereas an upbeat tone may trigger vibrant colors and dynamic entry effects.

In some aspects, the creative synthesis engine 708 may enforce scene timing and/or layout logic defined by the template (e.g., from template engine 704). For instance, the creative synthesis engine 708 may restrict text length based on placeholder width or constrain audio duration to align with the associated animation segment. In some configurations, the creative synthesis engine 708 may log or generate metadata describing timing alignment, rendering status, or available variant paths for downstream editing. In some instances, the output of the creative synthesis engine 708 may be a timeline of synchronized elements, which may be exported as a fully rendered video file or as a project for further editing.

In some cases, the system 700 may generate a synthetic video advertisement without selecting or instantiating a predefined video advertisement template. For example, the creative synthesis engine 708 may include or invoke a rendering logic module configured to assemble the synthetic video advertisement based on inferred layout and timing rules, rather than based on a predefined or generated template. That is, the creative synthesis engine 708 may use content-aware heuristics, tone-driven layout models, and/or spatial rendering logic to determine how to arrange visual and audio elements in a synthetic video advertisement.

In some configurations, the AI services module 706 may pass tone classifications, content tags, or content density scores to the creative synthesis engine 708, which may use these signals to organize the content sequence. In such configurations, the layout and timing of visual and audio elements may be inferred dynamically, without relying on a predefined video advertisement template. For instance, a minimal product image with ample whitespace may be expanded into a full-screen frame with overlaid text in a complementary position and timing determined by the rhythm of a synthesized voiceover.

In some cases, layout structure may be inferred by the creative synthesis engine 708 (e.g. via the rendering logic module) that applies default or learned design patterns, such as rule-of-thirds alignment for focal objects, time-based reveal sequences for multi-element ads, or pacing strategies tied to voiceover cadence. In some configurations, the system may store reusable layout primitives—such as “headline-fade-in,” “left-panel-image-right-panel-text,” or “bottom-third call-to-action”—which can be instantiated as needed without being tied to a global template.

In some examples, an approach that does not select or instantiate a template may be used in scenarios where: (i) no suitable predefined template exists, (ii) user input overrides template logic, and/or (iii) the system is operating in a freeform rendering mode (e.g., for exploratory creative generation). In such cases, downstream components such as the polishing agent 710 and ad delivery agent 712 may still function as normal, applying consistency refinements and delivery metadata to the resulting advertisement.

In some configurations, the polishing agent 710 may be applied to enhance the visual and auditory consistency of the synthetic video advertisement generated by the creative synthesis engine 708. For example, if product images from different sources show inconsistent lighting, the polishing agent 710 may apply brightness and contrast normalization. In another example, if a stock background is used alongside uploaded business photos, the system may extract a color swatch from the product and extend it into the background using gradient blending. In some aspects, the polishing agent 710 may implement audio normalization that can include loudness balancing, removal of silent gaps, and/or application of ambient background music to match the tone.

In some cases, the polishing agent 710 may enforce stylistic consistency by applying brand color overlays, font harmonization, or background animation alignment. In some cases, the polishing agent 710 may also analyze product images or video segments to ensure the presence of adequate “brand-safe space”—e.g., sufficient unobstructed area around the focal product for overlaying text or branding elements without visual interference. In some instances, if brand-safe space is insufficient, the system may generate a synthetic variant of the media asset that includes additional margin, extended background, or reframed composition to accommodate template constraints. In some implementations, a visual grammar engine may be used to adjust transitions and keyframe pacing to match platform-specific standards (e.g., vertical video rules for social platforms).

In some aspects, the completed advertisement may be provided to the ad delivery agent 712. In some cases, the ad delivery agent 712 may be configured to associate the synthetic video advertisement with metadata that can be used for targeting. In some examples, the metadata may include, for example, a display region (e.g., “Southeast U.S.”), time constraints (e.g., “weekday evenings”), channel type (e.g., “sports programming”), viewer segment (e.g., “young families with children”), genre type (e.g., romance), etc. For example, the system may tag an ad for laundry detergent with a preference for airing before or during a romance-based reality television program. In some instances, metadata may also include competitive exclusion rules (e.g., “do not air adjacent to rival plumbing services”).

In some configurations, the ad delivery agent 712 may be configured to dynamically personalize the advertisement at runtime based on metadata such as current weather, user location, or detected audience profile. For example, if a viewer is located in a region experiencing rainy weather, the system may substitute background visuals with indoor scenes. Alternatively, if the ad is being delivered to a Spanish-speaking household, the system may select a voiceover with a regional accent or a corresponding visual template with translated text overlays

In some examples, the system 700 may include a feedback engine 714 configured to monitor the performance of the generated synthetic video advertisement. For instance, the feedback engine 714 may collect view-through rate, click-through rate (for interactive ads), brand recall scores from user surveys, or content sentiment derived from real-time audience feedback. In some configurations, the feedback engine 714 may provide tuning signals to the AI services module 706 and/or the template engine 704. For example, if “urgent tone” ads for local home services outperform “calm tone” ads in a given region, the system may weight future tone selections accordingly. In some cases, this feedback loop may enable semi-automated A/B testing and evolutionary template optimization over time.

In some implementations, the feedback engine 714 may analyze engagement by region or user segment, such that ads can be automatically localized in response to observed geographic or demographic performance patterns. For instance, if a humorous ad style consistently underperforms with older viewers in rural areas, that tone may be avoided in future targeted campaigns for that group. In some configurations, the feedback engine 714 may also provide data signals to the user interface 702, such as recommended default settings or example templates that have previously performed well for similar business profiles.

In some implementations, the feedback engine 714 may include or interface with a similarity assessment module that is configured to analyze the structural or perceptual similarity between different synthetic video advertisements. For example, the feedback engine 714 may compare two ads based on a frame-by-frame visual analysis, comparing layout patterns, transitions, and timing of key elements. In some configurations, perceptual hashes, scene classification embeddings, or aesthetic signature vectors may be used to generate similarity scores. In some cases, these scores may be used to cluster high-performing ads, avoid overexposure of near-duplicate creatives, or rank template candidates based on visual resemblance to previously successful campaigns.

In some configurations, the similarity assessment module (e.g., within feedback engine 714) may compute similarity scores based on one or more feature types associated with historical and candidate synthetic video advertisements. These features may include layout metadata (e.g., spatial arrangement of modular elements), timing structure (e.g., duration and ordering of scenes or transitions), perceptual hash features derived from frame-level visual analysis, and aesthetic signature vectors representing color schemes, animation styles, or overall tone. These similarity scores may be used to retrieve or rank historical campaigns for comparison or to guide template selection for new advertisements.

In some configurations, performance metrics captured by the feedback engine 714 may be incorporated into future decision matrix evaluations for selecting a template (e.g., by template engine 704). For example, performance signals (e.g., first-view conversion rates, retention duration, engagement deltas, etc.) may be used to adjust the ranking of candidate templates (e.g., based on demonstrated effectiveness in similar campaign contexts).

In some implementations, the user interface 702 of system 700 may also be used after ad generation to preview the synthetic video advertisement and/or accept user edits. For example, the system 700 may allow the business to review the voiceover, adjust the tagline, swap out an image, or request regeneration of a given segment. Once the edits are received, the system 700 may reassemble the final output using updated assets and render a finalized version for approval. In some configurations, metadata associated with the original ad (e.g., targeting tags, timing constraints) may be preserved or updated based on the edits.

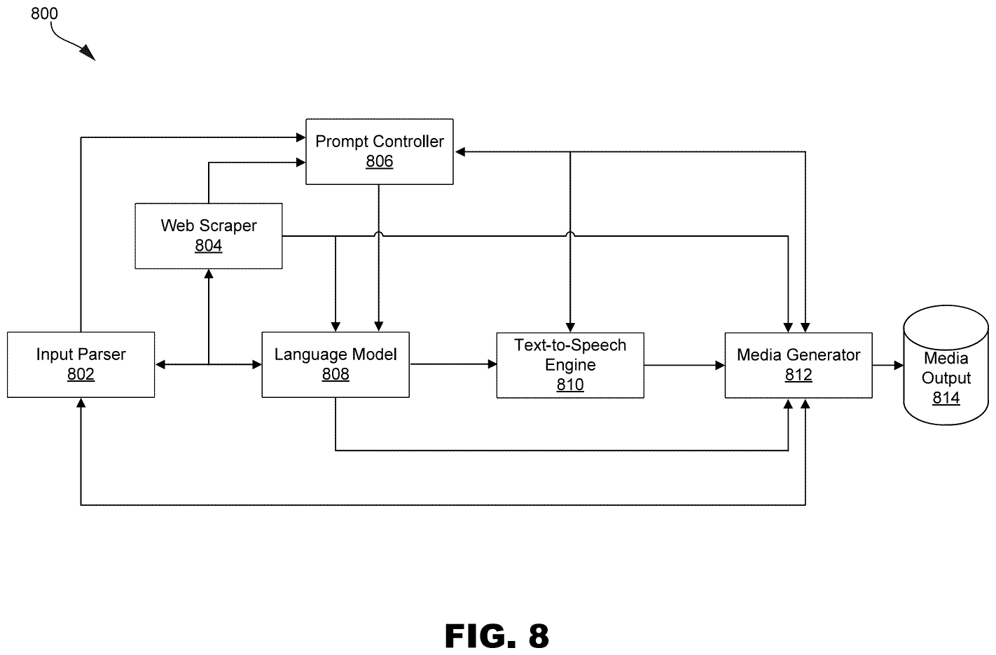

FIG. 8 illustrates a system 800 that may be used to generate media content components for use in a synthetic video advertisement. In some configurations, system 800 may be implemented as part of, or in communication with, the AI services module 706 of FIG. 7. System 800 can be configured to produce textual content, synthesized voiceover, and visual media assets (e.g., images or video segments) using a modular architecture that supports both direct data-driven logic and dynamic prompt orchestration.

As shown in FIG. 8, system 800 may include an input parser 802 configured to receive input data from a user interface, such as user-provided descriptions, structured business information, and/or selections from a guided survey. In some implementations, input parser 802 may normalize or pre-process the input data. For example, input parser 802 may convert input data into a standardized format, extract keywords, perform natural language parsing, map inputs to predefined attribute categories, etc. In some aspects, the parsed inputs may include business-specific attributes (e.g., “auto detailing service,” “promotional goal: local visibility”) and/or contextual parameters (e.g., “weekend scheduling,” “urban audience,” “demographic: retirees”).

In some configurations, input parser 802 may provide the parsed inputs to a web scraper 804. In some cases, the web scraper 804 may be configured to retrieve structured or semi-structured content from business-owned digital properties (e.g., websites, e-commerce listings, online profiles). In some examples, web scraper 804 may extract metadata such as product names, pricing tables, business hours, and/or customer reviews. In some cases, web scraper 804 may retrieve embedded images, banners, videos, or alt-text that describe visual or narrative content. In some implementations, the retrieved data may be passed to the prompt controller 806 for use in dynamic prompt construction, to the language model 808 for text generation context, or directly to the media generator 812 for evaluation as potential ad assets.

In some implementations, system 800 may include a prompt controller 806 configured to generate prompts for use by one or more AI-driven components. In some cases, the prompt controller 806 may be implemented using rule-based logic, templating infrastructure, or an adaptive orchestration framework. In some configurations, the prompt controller 806 may receive inputs from the input parser 802, which may provide contextual metadata such as the business's promotional goal, target audience segment, preferred tone or style, geographic focus, etc. In some cases, the contextual metadata may influence how a prompt is constructed, and which constraints are applied to guide generation. Additionally, or alternatively, the prompt controller 806 may receive template-specific metadata—such as required scene timing, placeholder types, or tone requirements—derived from the selected template structure (e.g., from template engine 704 of FIG. 7).

Based on these various inputs, the prompt controller 806 may construct one or more prompts for downstream AI modules, such as a language model 808 or media generator 812. In some cases, the prompt controller 806 may generate prompts that include structured business inputs, representative examples, stylistic instructions, or formatting constraints. In some examples, the prompt controller 806 may also coordinate multi-stage prompt chains, such as prompting a language model to extract key value propositions, then formatting those into a customer-facing script aligned with the target ad structure.

In some configurations, system 800 may also include a language model 808. In some cases, the language model 808 may be implemented as a transformer-based model fine-tuned for marketing copy or domain-specific advertisement generation. In some aspects, the language model 808 may be used to generate textual content such as product taglines, promotional statements, benefit descriptions, calls to action, or transitional phrases that are suitable for integration into a video advertisement. In various implementations, the language model 808 may receive input from the input parser 802—such as structured business attributes—or from the prompt controller 806, which may provide a formatted prompt that includes example outputs, tone modifiers, or structured instruction tokens.

In addition, or alternatively, the language model 808 may receive content or context retrieved by the web scraper 804. For example, if the web scraper 804 extracts a business description, product highlights, or customer testimonials from the business's website, that content may be used to ground or contextualize the text generated by the language model 808. In some examples, this may help ensure that the output of the language model 808 aligns closely with the business's actual offerings and branding language. In some configurations, the scraped content may be passed directly to the language model 808 or may be pre-processed by the input parser 802 or prompt controller 806 before use. The language model 808 may be further configured to handle special formatting requirements or token-level constraints (e.g., maximum character count, structured line breaks) based on the requirements of a particular content region, such as a modular element of the selected video advertisement template.

In some examples, system 800 may include a text-to-speech (TTS) engine 810 configured to synthesize audio narration based on the text output from language model 808 or prompt controller 806. In some implementations, the TTS engine 810 may support a library of voice models with distinct characteristics, including gender, pitch, speaking rate, accent, language, and emotional tone. For example, the TTS engine 810 may apply a warm, upbeat female voice with a Southern U.S. accent for a family-owned bakery, or a neutral male voice with a calm tone for a financial services firm. In some aspects, voice model selection may be determined based on the business's industry, regional targeting parameters, or explicit user preferences. In some cases, the TTS engine 810 may also support SSML (Speech Synthesis Markup Language) or internal tags to adjust intonation, add pauses, emphasize phrases, or align timing with visual transitions.

In some configurations, system 800 may include media generator 812, which may be used to select and/or synthesize media assets for inclusion in the video advertisement. In some cases, the media generator 812 may perform asset selection by retrieving images, video clips, logos, or other media from stock libraries, scraped content obtained via web scraper 804, or user-uploaded files.

In addition to media selection, media generator 812 may be capable of generating synthetic or transformed assets using one or more AI-based tools. For example, the media generator 812 may apply image stylization filters to match a target aesthetic, use animation techniques to convert a static product photo into a short panning video segment, or generate stylized background images based on product attributes and color palettes. In some instances, the media generator 812 may also incorporate visual refinement operations, such as cropping, resizing, brightness and contrast adjustment, or background extension using dominant color swatches.

In some implementations, the media generator 812 may also evaluate whether a given product image or video frame includes sufficient brand-safe space—that is, unobstructed space around the product suitable for overlaying text, logos, or other branding elements. If the original media lacks such space, the system may generate a modified version using background extension, intelligent reframing, or margin synthesis to maintain visual clarity while preserving template constraints.

In some implementations, media generator 812 may coordinate with prompt controller 806 to apply style guidance or narrative constraints to the selected or generated content. For instance, if the prompt controller 806 specifies a tone of “elegant and minimal,” the media generator 812 may favor clean background templates and subtle animations over bold visual effects. In some examples, the media generator812 may also consider layout constraints derived from the selected template structure, such as spatial dimensions, duration of media slots, and available overlay regions for text or logos.

In some cases, the output of media generator 812 may be stored in media output 814, which may correspond to a repository or data structure containing finalized or partially populated assets for use in the subsequent ad assembly process. The media output 814 may include rendered voiceover audio tracks, populated image sequences, text overlays, and timing metadata. In some cases, media output 814 may support storage of multiple creative variants or alternative content sets for A/B testing, demographic targeting, or performance-based optimization. These assets may subsequently be provided to a creative synthesis engine (e.g., 708 of FIG. 7) for integration into a finalized synthetic video advertisement.

In some examples, media generator 812 may return one or more signals to input parser 802 or prompt controller 806 indicating generation outcomes, quality scores, or constraint violations. For example, if a retrieved image is below minimum resolution or if the synthesized voiceover exceeds a predefined duration, a feedback signal may prompt the input parser 802 to adjust its data, or prompt controller 806 to recompose its prompt using different tone or formatting parameters. In this manner, system 800 may support adaptive regeneration of individual components, prompt tuning based on synthesis outcomes, and semi-automated correction of constraint mismatches prior to final ad assembly.

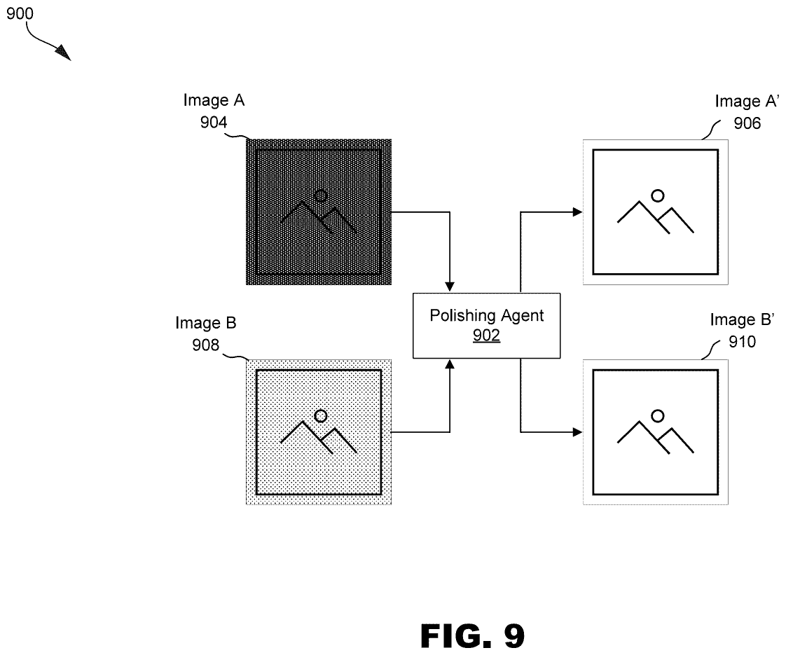

FIG. 9 illustrates a system 900 that may be used to perform aesthetic normalization of media assets for use in a synthetic video advertisement. In some implementations, the system 900 may be implemented using or in conjunction with a polishing agent (e.g., polishing agent 710 of FIG. 7), which is configured to apply one or more aesthetic adjustments to visual assets obtained from a variety of sources.

As shown in FIG. 9, the system 900 may receive a plurality of unprocessed media assets, such as Image A 904 and Image B 908. In some examples, these media assets may originate from different sources, such as stock libraries, scraped web content, or user-uploaded files. As a result, they may exhibit visually inconsistent characteristics. For example, Image A 904 may include dark lighting and poor contrast, while Image B 908 may contain a color cast or a noisy background. In some cases, inconsistencies between image A 904 and image B 908 may result in jarring transitions or a lack of visual cohesion when the images are assembled into a modular video advertisement.

In some examples, the polishing agent 902 may be configured to apply one or more transformations to media inputs in order to enhance visual consistency. In some implementations, the polishing agent 902 may perform operations such as background blending, color temperature normalization, contrast adjustment, resolution upscaling, and/or tone mapping. In some cases, polishing agent 902 may apply adjustments individually to each image. In some aspects, polishing agent 902 may identify and use shared aesthetic parameters or style goals to ensure that the resulting images are visually harmonized.

In some cases, the output of the polishing agent 902 may include revised versions of the original media, such as Image A′ 906 and Image B′ 910. In some configurations, the polished outputs may be aligned with the visual tone or theme of a selected video advertisement template.

For example, if the selected template emphasizes a bright, clean aesthetic, the polishing agent 902 may ensure that shadows are softened and background colors are lightened across all media elements. In other cases, the polishing process may correct technical deficiencies, such as ensuring that all assets meet a minimum resolution threshold or fit within a consistent aspect ratio.

In some implementations, the polishing agent 902 may also generate metadata describing the aesthetic attributes of the processed media (e.g., dominant color swatches, brightness scores, tone profiles, etc.). This metadata may be used by downstream components—such as a creative synthesis engine or an ad delivery agent—to further customize the presentation of the synthetic video advertisement. In some cases, the polishing process may be fully automated, while in other cases it may be augmented by user feedback, template-defined rules, or iterative refinement based on rendering constraints.

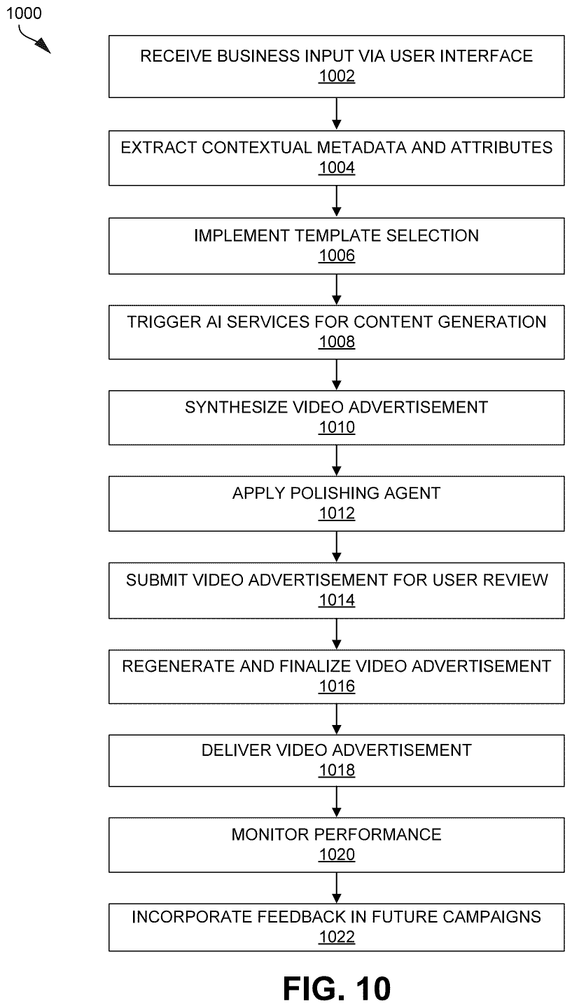

FIG. 10 is a flowchart for a method 1000 for generating a synthetic video advertisement. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 1000 shall be described with reference to FIG. 7. However, method 1000 is not limited to that example.

In step 1002, the method 1000 includes receiving business input via a user interface. For example, user interface 702 may be used to receive data from a business such as a product or service description (e.g., “pressure washing service”), promotional goal (e.g., “flash sale”), industry (e.g., “home maintenance”), or uploaded brand assets (e.g., logo, sample image). In some configurations, the user interface 702 may retrieve metadata automatically from a business website or online profile, or suggest pre-filled values based on similar campaigns.

In step 1004, the method 1000 includes extracting contextual metadata and attributes from the received input and external sources. For example, AI services module 706 may be configured to extract structured information such as business hours, service area, or pricing tiers. In some cases, the module may also infer additional attributes, such as urgency level, recurrence pattern, seasonal relevance, or competitive context. In some aspects, these extracted attributes may be passed as inputs to downstream modules including the template engine and content generation services.

In step 1006, the method 1000 includes implementing template selection based on the extracted metadata. For instance, template engine 704 may select or construct a template structure that is based on the input data and that is aligned with the business's promotional context. For example, a template for a seasonal restaurant ad may include modules for a headline, imagery carousel, testimonial, and call-to-action segment. In some cases, the template selection process may rely on rule-based logic, decision matrices, or adaptive models informed by industry heuristics and historical performance metrics. In some implementations, template selection may be skipped, and layout structure may be determined dynamically based on the input data and available assets. In such configurations, the system may use rendering heuristics or learned layout models to define element timing, placement, and transitions.

In step 1008, the method 1000 includes triggering AI services for content generation. For example, AI services module 706 may use a language model to generate promotional copy, a text-to-speech engine to synthesize narration, and a media selector to retrieve relevant product images from stock libraries or business sources. In some cases, content generation is guided by prompts that reflect template constraints, tone guidance, and inferred campaign goals.

In step 1010, the method 1000 includes synthesizing a video advertisement by assembling content into the selected template. For example, creative synthesis engine 708 may combine generated text, images, voiceover, and transition animations into a timed sequence, ensuring that the final output adheres to layout constraints (e.g., aspect ratio) and timing rules (e.g., scene duration or voiceover alignment).

In step 1012, the method 1000 includes applying a polishing agent to improve visual and auditory cohesion. For instance, polishing agent 710 may normalize brightness across mixed images, adjust volume levels, apply audio smoothing, and harmonize the background to match brand colors. In some cases, polishing may also involve adding background music or atmospheric cues to improve viewer engagement.

In step 1014, the method 1000 includes submitting the video advertisement for user review. For example, user interface 702 may present the generated video to a business user with options to review narration, edit taglines, replace visuals, or request regeneration of specific segments. In some instances, suggested edits may be informed by feedback signals or campaign benchmarks for similar profiles.

In step 1016, the method 1000 includes regenerating and finalizing the video advertisement based on user input. For example, AI services module 706 may update content according to user edits, while creative synthesis engine 708 re-assembles and aligns the video timeline. In some aspects, polishing agent 710 may be re-applied to ensure that any changes maintain consistency. In some examples, campaign metadata (e.g., targeting parameters) may be preserved or revised as needed.

In step 1018, the method 1000 includes delivering the video advertisement to one or more destinations. For instance, ad delivery agent 712 may transmit the final video to connected TV platforms, social media channels, or programmatic ad exchanges. In some configurations, the system may associate the advertisement with metadata such as target region (e.g., “Florida Panhandle”), delivery schedule (e.g., weekday mornings), audience segment (e.g., “parents with toddlers”), genre affinity (e.g., “DIY programming”), and/or competitive exclusion criteria (e.g., do not air adjacent to ads for similar services).

In step 1020, the method 1000 includes monitoring the performance of the delivered advertisement. For example, feedback engine 714 may collect view-through rates, engagement metrics, sentiment signals, brand recall data, or conversion outcomes. In some instances, these performance metrics may be analyzed at fine-grained levels such as time of day, region, or content variation (e.g., different taglines or voiceover styles).

In step 1022, the method 1000 includes incorporating feedback in future campaigns. For instance, feedback engine 714 may forward performance insights to template engine 704 to prioritize effective layouts, to AI services module 706 to tune content generation models, and to user interface 702 to pre-populate fields or suggest proven configurations for similar businesses. In some instances, such a configuration can be used to enable evolutionary learning across campaigns and improve ad effectiveness based on real-world results.

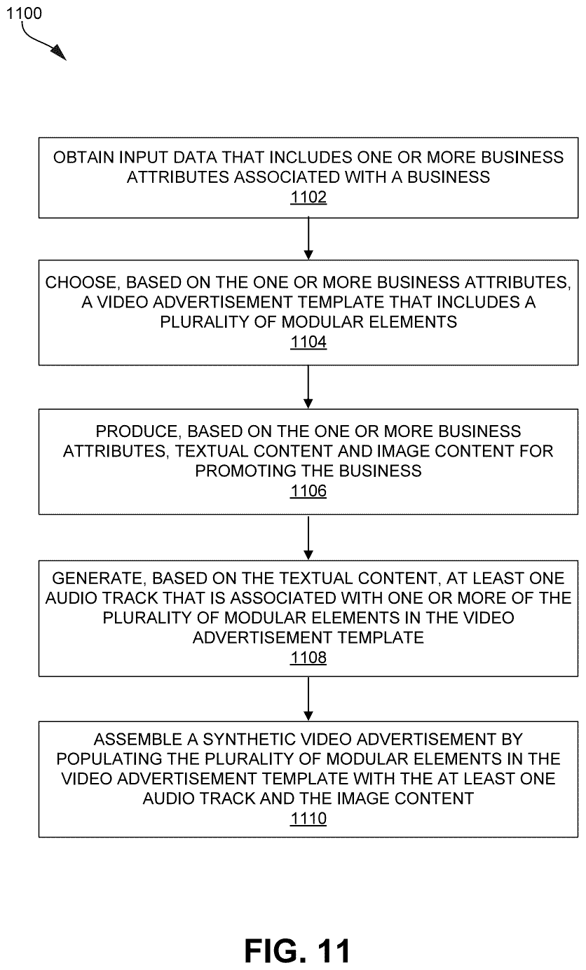

FIG. 11 is a flowchart for a method 1100 for generating a synthetic video advertisement. Method 1100 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art.

Method 1100 shall be described with reference to FIG. 7. However, method 1100 is not limited to that example.

In step 1102, the method 1100 includes obtaining input data that includes one or more business attributes associated with a business. For example, user interface 702 can be used to collect input data that includes one or more business attributes. Examples of business attributes can include a product or service type (e.g., “organic soap,” “auto detailing”), the business's industry category (e.g., “personal care,” “automotive”), recurrence patterns (e.g., recurring weekly service versus one-time offer), and/or promotional objectives (e.g., “store visit” or “brand awareness”).

In some aspects, input data may also include contextual parameters such as geographic region (e.g., “Miami”), time of day (e.g., “weekday mornings”), media environment (e.g., mobile versus connected TV), target audience characteristics (e.g., “young professionals”), and/or weather-related indicators (e.g., “rainy conditions”). In some configurations, user interface 702 may retrieve data automatically from a business website or online profile using scraping functions provided by AI services module 706.

In step 1104, the method 1100 includes choosing, based on the one or more business attributes, a video advertisement template that includes a plurality of modular elements. For instance, template engine 704 can choose (e.g. select or generate) a video advertisement template based on the one or more business attributes. In some cases, template engine 704 can select a suitable template from a predefined template library or generate a new template dynamically based on business inputs. For example, the system may choose a hospitality-style layout for a restaurant or a testimonial-driven format for a medical clinic. In some implementations, the template selection may involve evaluating industry-specific heuristics or performance-informed matrices. In some examples, the template may define spatial layout, element duration, transition styles, and alignment logic, which can be passed downstream for population and rendering. In some cases, template engine 704 may generate a new template (e.g., instead of selecting a pre-defined template). In some instances, the system may operate without selecting a predefined video advertisement template and/or generating a new template (e.g., the layout and sequencing of elements may be determined dynamically based on content characteristics and inferred rendering rules).

In step 1106, the method 1100 includes producing, based on the one or more business attributes, textual content and image content for promoting the business. For example, AI services module 706 may produce textual content and/or image content for promoting the business. In some cases, AI services module 706 can generate promotional text using a transformer-based language model. In some examples, this text can include benefit-driven statements, emotional taglines, or persuasive calls to action (e.g., tailored to the business's tone and industry). In some aspects, image content may be selected from a stock media library, retrieved from the business's website, or uploaded directly by the business. In some configurations, image frames may be animated (e.g., with pan, zoom, and transition effects) to create dynamic short video clips suitable for integration into the selected template.

In step 1108, the method 1100 includes generating, based on the textual content, at least one audio track that is associated with one or more of the plurality of modular elements in the video advertisement template. For instance, AI services module 706 can use textual content to generate an audio track that is associated with a module element of the video advertisement template. For example, AI services module 706 can use a text-to-speech (TTS) engine to synthesize a voiceover from the promotional copy. In some instances, the system may offer various voice models, enabling selection based on language, regional accent, tone (e.g., warm, urgent), or gender preferences aligned with the target audience and brand persona. In some cases, the textual content provided to the TTS engine may also be localized using regional lexicon to ensure the synthesized speech reflects local phrasing conventions.

In step 1110, the method 1100 includes assembling a synthetic video advertisement by populating the plurality of modular elements in the video advertisement template with the at least one audio track and the image content. For example, creative synthesis engine 708 can assemble a synthetic video advertisement by populating modular elements in the video advertisement template with the audio track and image content. In some cases, creative synthesis engine 708 can align the synthesized content according to the structural rules defined by the template. For example, the creative synthesis engine 708 may synchronize audio with transitions, enforce layout constraints, and respect duration limits per scene. In some cases, polishing agent 710 may apply aesthetic adjustments, such as brightness normalization, tone harmonization, or color blending to ensure visual consistency across diverse media elements. In some examples, audio may be adjusted for loudness normalization and silence trimming. In some cases, placement of text within the advertisement may be machine-learning optimized based on tone or emotional style—for example, by selecting text color, font, screen position, and animation parameters to enhance alignment with the ad's messaging style.

In some configurations, ad delivery agent 712 may associate metadata with the synthetic video advertisement prior to delivery. In some aspects, the metadata may include demographic targeting (e.g., “urban parents”), time slot preferences (e.g., “weekday primetime”), preferred channel type (e.g., sports programming), genre association (e.g., “reality entertainment”), geographic region (e.g., “Southeast U.S.”), and competitive exclusion tags (e.g., “do not air next to competitor brands”).

In some aspects, user interface 702 may also be used to present a preview of the assembled advertisement to the business for review. In response to user input, the system may receive edits such as revised copy, image substitutions, or alternate voiceover selections. The updated assets may then be passed back to the creative synthesis engine 708 for regeneration, resulting in a finalized version of the synthetic video advertisement that incorporates the user edits and preserves any targeting metadata.

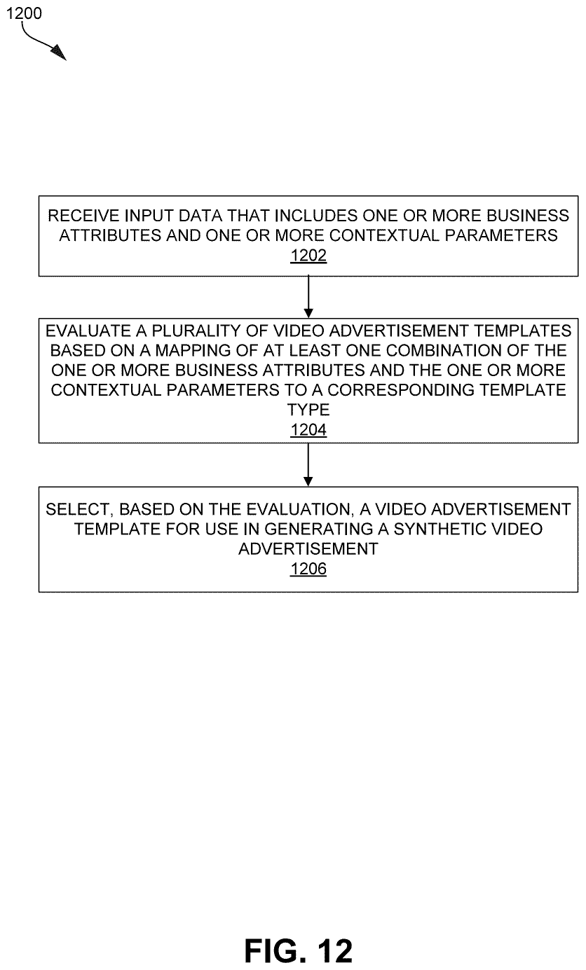

FIG. 12 is a flowchart for a method 1200 for selecting a video advertisement template. Method 1200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art.

Method 1200 shall be described with reference to FIG. 7. However, method 1200 is not limited to that example.

In step 1202, the method 1200 includes receiving input data that includes one or more business attributes and one or more contextual parameters. For example, system 700 (as illustrated in FIG. 7) may receive input data via user interface 702. In some cases, the input data can include business attributes such as a product type (e.g., “organic shampoo”), service type (e.g., “window cleaning”), an associated industry (e.g., “automotive repair”), a recurrence pattern (e.g., weekly vs. one-time), or a promotional goal (e.g., brand awareness, seasonal promotion, or customer reactivation). In some examples, the contextual parameters may include, for instance, a geographic region (e.g., “Chicago, IL”), a time of day (e.g., “morning broadcast slot”), a media environment (e.g., “connected TV,” “mobile app”), a target audience profile (e.g., “millennial parents”), and/or even external conditions such as weather (e.g., “rainy day targeting for car detailing”).

In some implementations, the input data may be partially retrieved by the system itself. For example, the system may query a business's website or social media profile to prefill information such as the service category, hours of operation, product descriptions, or visual assets. In some implementations, this may be done by the AI services module 706 (e.g., via a web scraper component) or another data ingestion mechanism.

In step 1204, the method 1200 includes evaluating a plurality of video advertisement templates based on a mapping of at least one combination of the one or more business attributes and the one or more contextual parameters to a corresponding template type. In some cases, template engine 704 may evaluate available templates according to a decision matrix or rule engine. The matrix may include rules that associate certain business types and promotional conditions with specific template archetypes. For instance, a one-time sale for a retail brand might be mapped to a fast-paced, image-driven format, while a recurring legal service may be mapped to a template featuring voiceover and testimonial sections.

In some aspects, the template evaluation may be based on static mappings, business rules, or a trained model that predicts appropriate template categories given the input profile. In some cases, the mappings may also include industry-specific heuristics. For example, ads targeting luxury vacation rentals might emphasize scenic visuals and pacing, whereas ads for emergency plumbing services might emphasize clarity of offer and urgency in voiceover timing. In some implementations, template evaluation may also reference a graph of previously deployed synthetic advertisements, identifying layout formats that have shown strong performance in similar targeting conditions.

In step 1206, the method 1200 includes selecting, based on the evaluation, a video advertisement template for use in generating a synthetic video advertisement. In some cases, the template may include a set of modular elements such as an intro text slot, a carousel of product images, a call-to-action region, or a designated voiceover track. In some examples, the template engine 704 may retrieve the template from a predefined library or dynamically generate a new one by composing modular segments based on the evaluation results.

In some configurations, template selection may be informed by past campaign results without requiring them. That is, even in the absence of historical synthetic ad performance, the system can rely on default mappings, business type heuristics, or contextual alignment scores. For example, a new campaign for a dog grooming service could be matched to a template designed for recurring home services with high personalization value, based on attribute-based rules.

In some aspects, once a template is selected, the template may be passed to downstream modules, including the AI services module 706 and the creative synthesis engine 708, for populating the template with text, image, and audio content (e.g., as described in connection with FIG. 7). The system may also generate metadata associated with the selected template and planned delivery. In some examples, this metadata may include a preferred display time (e.g., weekday mornings), a content genre (e.g., comedy programming), a competitive exclusion rule (e.g., exclude ads from competitors), or a geographic targeting zone.

In some implementations, the user interface 702 may be used to preview the selected template and allow the user to override or adjust the selection. The system may then finalize the synthetic ad and associate it with the delivery metadata for use by the ad delivery agent 712.

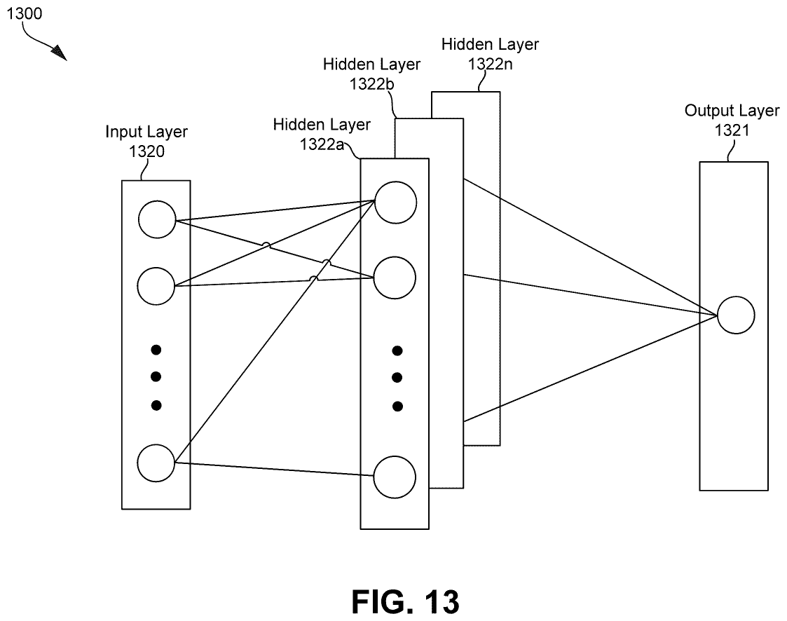

FIG. 13 is a diagram illustrating an example of a neural network architecture 1300 that can be used to implement some or all of the neural networks described herein. The neural network architecture 1300 can include an input layer 1320 can be configured to receive and process data to generate one or more outputs. The neural network architecture 1300 also includes hidden layers 1322a, 1322b, through 1322n. The hidden layers 1322a, 1322b, through 1322n include “n” number of hidden layers, where “n” is an integer greater than or equal to one. The number of hidden layers can be made to include as many layers as needed for the given application. The neural network architecture 1300 further includes an output layer 1321 that provides an output resulting from the processing performed by the hidden layers 1322a, 1322b, through 1322n.

The neural network architecture 1300 is a multi-layer neural network of interconnected nodes. Each node can represent a piece of information. Information associated with the nodes is shared among the different layers and each layer retains information as information is processed. In some cases, the neural network architecture 1300 can include a feed-forward network, in which case there are no feedback connections where outputs of the network are fed back into itself. In some cases, the neural network architecture 1300 can include a recurrent neural network, which can have loops that allow information to be carried across nodes while reading in input.

Information can be exchanged between nodes through node-to-node interconnections between the various layers. Nodes of the input layer 1320 can activate a set of nodes in the first hidden layer 1322a. For example, as shown, each of the input nodes of the input layer 1320 is connected to each of the nodes of the first hidden layer 1322a. The nodes of the first hidden layer 1322a can transform the information of each input node by applying activation functions to the input node information. The information derived from the transformation can then be passed to and can activate the nodes of the next hidden layer 1322b, which can perform their own designated functions. Example functions include convolutional, up-sampling, data transformation, and/or any other suitable functions. The output of the hidden layer 1322b can then activate nodes of the next hidden layer, and so on. The output of the last hidden layer 1322n can activate one or more nodes of the output layer 1321, at which an output is provided. In some cases, while nodes in the neural network architecture 1300 are shown as having multiple output lines, a node can have a single output and all lines shown as being output from a node represent the same output value.

In some cases, each node or interconnection between nodes can have a weight that is a set of parameters derived from the training of the neural network architecture 1300. Once the neural network architecture 1300 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 1300 to be adaptive to inputs and able to learn as more and more data is processed.

The neural network architecture 1300 is pre-trained to process the features from the data in the input layer 1320 using the different hidden layers 1322a, 1322b, through 1322n in order to provide the output through the output layer 1321.

In some cases, the neural network architecture 1300 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 1300 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 1300 can perform a backward pass by determining which inputs (weights) most contributed to the loss of the network, and can adjust the weights so that the loss decreases and is eventually minimized.

The neural network architecture 1300 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 1300 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: one or more memories; and at least one processor coupled to at least one of the one or more memories and configured to perform operations comprising: obtain input data that includes one or more business attributes associated with a business; choose, based on the one or more business attributes, a video advertisement template that includes a plurality of modular elements; produce, based on the one or more business attributes, textual content and image content for promoting the business; generate, based on the textual content, at least one audio track that is associated with one or more of the plurality of modular elements in the video advertisement template; and assemble a synthetic video advertisement by populating the plurality of modular elements in the video advertisement template with the at least one audio track and the image content.

Aspect 2. The system of Aspect 1, wherein the input data includes at least one of a product type, a service type, an industry, a recurrence, and a promotional goal.

Aspect 3. The system of any of Aspects 1 to 2, wherein the input data includes at least one contextual parameter, the contextual parameter including one or more of a geographic region, a time of day, a media environment, a target audience profile, and a weather condition.

Aspect 4. The system of any of Aspects 1 to 3, wherein to obtain the input data the at least one processor is configured to: retrieve the input data from a website associated with the business.

Aspect 5. The system of any of Aspects 1 to 4, wherein to choose the video advertisement template the at least one processor is configured to: select the video advertisement template from a predefined library of templates based on the one or more business attributes.

Aspect 6. The system of any of Aspects 1 to 5, wherein to choose the video advertisement template the at least one processor is configured to: generate the video advertisement template based on the one or more business attributes.

Aspect 7. The system of any of Aspects 1 to 6, wherein to produce the textual content the at least one processor is configured to: generate, using a language model, at least one of a benefit statement, a tagline, and a call to action.

Aspect 8. The system of any of Aspects 1 to 7, wherein to produce the image content the at least one processor is configured to: select one or more images from an image library based on the one or more business attributes.

Aspect 9. The system of any of Aspects 1 to 8, wherein to produce the image content the at least one processor is configured to: generate a video segment by animating at least one image frame included in the input data.

Aspect 10. The system of any of Aspects 1 to 9, wherein to generate the at least one audio track the at least one processor is configured to: synthesize a voiceover using a text-to-speech model based on the textual content.

Aspect 11. The system of any of Aspects 1 to 10, wherein the at least one processor is configured to: perform one or more aesthetic adjustments on the synthetic video advertisement, wherein the one or more aesthetic adjustments include at least one of blending a background color, adjusting an image brightness, and balancing a visual tone across the plurality of modular elements.

Aspect 12. The system of any of Aspects 1 to 11, wherein the at least one processor is configured to: generate metadata that is associated with the synthetic video advertisement, wherein the metadata includes at least one of a target audience demographic, a preferred display time, a preferred display channel, a preferred content genre, a geographic location, and a competitive exclusion indicator.

Aspect 13. The system of any of Aspects 1 to 12, wherein the at least one processor is configured to: present, via a user interface, a preview of the synthetic video advertisement; receive, via the user interface, one or more edits to at least one of the textual content, the image content, and the at least one audio track; and render a finalized version of the synthetic video advertisement based on the one or more edits.

Aspect 14. The system of any of Aspects 1 to 13, wherein the at least one processor is configured to: analyze the image content to determine whether it includes sufficient brand-safe space surrounding a product; and generate a modified version of the image content if the brand-safe space is insufficient.

Aspect 15. The system of Aspect 14, wherein the brand-safe space is determined using a segmentation model that identifies unobstructed background regions around the product.

Aspect 16. The system of any of Aspects 14 to 15, wherein the modified version of the image content is generated using a background extension or margin synthesis model.

Aspect 17. The system of any of Aspects 1 to 16, wherein the at least one processor is configured to: classify a tone associated with the synthetic video advertisement based on the input data and select a text layout configuration based on the tone classification, the text layout configuration including at least one of a text color, font, position, and animation style.

Aspect 18. The system of Aspect 17, wherein the tone classification is selected from a set of tone profiles including humorous, calming, professional, urgent, and celebratory.

Aspect 19. The system of any of Aspects 1 to 18, wherein the at least one processor is configured to: select a regional variant of a phrase based on a geographic parameter included in the input data.

Aspect 20. The system of any of Aspects 1 to 19, wherein the at least one processor is configured to: compute a similarity score between the input data and a plurality of historical advertising campaigns; and select the video advertisement template based on the similarity score.

Aspect 21. The system of Aspect 20, wherein the similarity score is based on one or more of layout metadata, perceptual hash features, aesthetic signature vectors, and timing structure.

Aspect 22. The system of any of Aspects 1 to 21, wherein the at least one processor is configured: to analyze performance data associated with previously delivered advertisements; and adjust a template selection model based on structural attributes correlated with high performance.

Aspect 23. The system of Aspect 22, wherein the structural attributes include modular sequencing, animation duration, voiceover alignment, or visual balance heuristics.

Aspect 24. A computer-implemented method comprising performing the operations of any of Aspects 1 to 23.

Aspect 25. A system comprising means for performing the operations of any of Aspects 1 to 23.

Aspect 26. A non-transitory computer-readable medium having instructions stored thereon that, when executed by one or more processors, cause the one or more processors to perform operations according to any of Aspects 1 to 23.

What is claimed is:

1. A system comprising:
one or more memories; and
at least one processor coupled to at least one of the one or more memories and configured to perform operations comprising:
obtain input data that includes one or more business attributes associated with a business;
choose, based on the one or more business attributes, a video advertisement template that includes a plurality of modular elements;
produce, based on the one or more business attributes, textual content and image content for promoting the business;
generate, based on the textual content, at least one audio track that is associated with one or more of the plurality of modular elements in the video advertisement template; and
assemble a synthetic video advertisement by populating the plurality of modular elements in the video advertisement template with the at least one audio track and the image content.

2. The system of claim 1, wherein the input data includes at least one of a product type, a service type, an industry, a recurrence, and a promotional goal.

3. The system of claim 1, wherein the input data includes at least one contextual parameter, the contextual parameter including one or more of a geographic region, a time of day, a media environment, a target audience profile, and a weather condition.

4. The system of claim 1, wherein to obtain the input data the at least one processor is configured to:
retrieve the input data from a website associated with the business.

5. The system of claim 1, wherein to choose the video advertisement template the at least one processor is configured to:
select the video advertisement template from a predefined library of templates based on the one or more business attributes.

6. The system of claim 1, wherein to choose the video advertisement template the at least one processor is configured to:
generate the video advertisement template based on the one or more business attributes.

7. The system of claim 1, wherein to produce the textual content the at least one processor is configured to:
generate, using a language model, at least one of a benefit statement, a tagline, and a call to action.

8. The system of claim 1, wherein to produce the image content the at least one processor is configured to:
select one or more images from an image library based on the one or more business attributes.

9. The system of claim 1, wherein to produce the image content the at least one processor is configured to:
generate a video segment by animating at least one image frame included in the input data.

10. The system of claim 1, wherein to generate the at least one audio track the at least one processor is configured to:
synthesize a voiceover using a text-to-speech model based on the textual content.

11. The system of claim 1, wherein the at least one processor is configured to:
perform one or more aesthetic adjustments on the synthetic video advertisement, wherein the one or more aesthetic adjustments include at least one of blending a background color, adjusting an image brightness, and balancing a visual tone across the plurality of modular elements.

12. The system of claim 1, wherein the at least one processor is configured to:
generate metadata that is associated with the synthetic video advertisement, wherein the metadata includes at least one of a target audience demographic, a preferred display time, a preferred display channel, a preferred content genre, a geographic location, and a competitive exclusion indicator.

13. The system of claim 1, wherein the at least one processor is configured to:
present, via a user interface, a preview of the synthetic video advertisement;
receive, via the user interface, one or more edits to at least one of the textual content, the image content, and the at least one audio track; and
render a finalized version of the synthetic video advertisement based on the one or more edits.

14. A computer-implemented method comprising:
obtaining input data that includes one or more business attributes associated with a business;
choosing, based on the one or more business attributes, a video advertisement template that includes a plurality of modular elements;
producing, based on the one or more business attributes, textual content and image content for promoting the business;
generating, based on the textual content, at least one audio track that is associated with one or more of the plurality of modular elements in the video advertisement template; and
assembling a synthetic video advertisement by populating the plurality of modular elements in the video advertisement template with the at least one audio track and the image content.

15. The computer-implemented method of claim 14, wherein the input data includes at least one of a product type, a service type, an industry, a recurrence, and a promotional goal.

16. The computer-implemented method of claim 14, wherein the input data includes at least one contextual parameter, the contextual parameter including one or more of a geographic region, a time of day, a media environment, a target audience profile, and a weather condition.

17. The computer-implemented method of claim 14, wherein producing the image content further comprises:
generating a video segment by animating at least one image frame included in the input data.

18. The computer-implemented method of claim 14, wherein generating the at least one audio track further comprises:
synthesizing a voiceover using a text-to-speech model based on the textual content.

19. The computer-implemented method of claim 14, further comprising:
performing one or more aesthetic adjustments on the synthetic video advertisement, wherein the one or more aesthetic adjustments include at least one of blending a background color, adjusting an image brightness, and balancing a visual tone across the plurality of modular elements.

20. A non-transitory computer-readable medium having instructions stored thereon that, when executed by one or more processors, cause the one or more processors to perform operations comprising:
obtain input data that includes one or more business attributes associated with a business;
choose, based on the one or more business attributes, a video advertisement template that includes a plurality of modular elements;
produce, based on the one or more business attributes, textual content and image content for promoting the business;
generate, based on the textual content, at least one audio track that is associated with one or more of the plurality of modular elements in the video advertisement template; and
assemble a synthetic video advertisement by populating the plurality of modular elements in the video advertisement template with the at least one audio track and the image content.
